(19) United States
(12) Patent Application Publication
(10) Pub. No.: US 2026/0074828 A1
(43) Pub. Date: Mar. 12, 2026

(54) METHODS, SYSTEMS, AND APPARATUS FOR CHANNEL-DEPENDENT ERROR CORRECTION CODING

(71) Applicant: Huawei Technologies, Co., Ltd., Shenzhen (CN)

(72) Inventors: Huazi Zhang, Hangzhou (CN); Jianglei Ma, Ottawa (CA); Jun Wang, Hangzhou (CN); Yiqun Ge, Ottawa (CA); Xiaoyan Bi, Shanghai (CN); Peiying Zhu, Ottawa (CA); Wen Tong, Ottawa (CA)

(21) Appl. No.: 19/335,884

(22) Filed: Sep. 22, 2025

Related U.S. Application Data
(63) Continuation of application No. PCT/CN2023/111102, filed on Aug. 3, 2023.
(60) Provisional application No. 63/454,070, filed on Mar. 23, 2023.

(51) Int. Cl. H04L 1/00

(52) U.S. Cl. CPC H04L 1/0057

(57) ABSTRACT

Blocks of encoded bits are obtained by encoding input bits, and are output, for transmission for example. Each of the blocks of encoded bits has a respective associated code rate and a respective associated capacity. The blocks of encoded bits include nested blocks, and each nested block includes a subcode of another one of the blocks of encoded bits that has a higher respective associated code rate than the nested block. The nested blocks include coupled blocks that are coupled to each other. The coupled blocks may provide or support such features as any one or more of the following: flexible output order based on blockwise code rate and capacity, flexible decoding order based on blockwise code rate and capacity, or variable blockwise code rate.

### CROSS-REFERENCE TO RELATED APPLICATIONS

The present application is a continuation of International Application No. PCT/CN2023/111102, entitled “METHODS, SYSTEMS, AND APPARATUS FOR CHANNEL-DEPENDENT ERROR CORRECTION CODING” and filed on Aug. 3, 2023, and which claims the benefit of U.S. provisional patent application Ser. No. 63/454,070, entitled “Methods, Systems, and Apparatus for Channel-dependent Error Correction Coding”, filed on Mar. 23, 2023.

The present application is related to the following Patent Cooperation Treaty (PCT) applications by the same applicant:
PCT Application No. PCT/CN2023/083350, entitled “Methods, Systems, and Apparatus for Non-Sequential Decoding of Polar Codes”, filed on Mar. 23, 2023;
PCT Application No. PCT/CN2023/083348, entitled “Methods, Systems, and Apparatus for Bit Value Placement in Polar Coding”, filed on Mar. 23, 2023;
PCT Application No. PCT/CN2023/083345, entitled “Methods, Systems, and Apparatus for Encoded Bit Reduction in Polar Coding”, filed on Mar. 23, 2023;
PCT Application No. PCT/CN2023/097662, entitled “Methods, Systems, and Apparatus for Protograph-based Low Density Parity Check Coding”, filed on May 31, 2023;
PCT Application No. PCT/CN2023/092465, entitled “Methods, Systems, Apparatus for Partial Code Rate Reduction in Polar Coding”, filed on May 6, 2023;
PCT Application No. PCT/CN2023/102653, entitled “Methods, Systems, and Apparatus for Rateless Polar Coding”, filed on Jun. 27, 2023; and
PCT Application No. PCT/CN2023/103893, entitled “Methods, Systems, and Apparatus for Rateless Polar Coding and Low-complexity Decoding”, filed on Jun. 29, 2023, and is related to the following United States provisional patent applications as well:
U.S. provisional patent application Ser. No. 63/454,066, entitled “Methods, Systems, and Apparatus for Partial Code Rate Reduction in Polar Coding”, filed on Mar. 23, 2023;
U.S. provisional patent application Ser. No. 63/454,067, entitled “Methods, Systems, and Apparatus for Rateless Polar Coding”, filed on Mar. 23, 2023;
U.S. provisional patent application Ser. No. 63/454,068, entitled “Methods, Systems, and Apparatus for Rateless Polar Coding and Low-complexity Decoding”, filed on Mar. 23, 2023; and
U.S. provisional patent application Ser. No. 63/454,069, entitled “Methods, Systems, and Apparatus for Rateless Polar Coding and Incremental Redundancy”, filed on Mar. 23, 2023.

The disclosures of the aforementioned applications are hereby incorporated by reference in their entireties.

### TECHNICAL FIELD

The present application relates to coding, and in particular to channel-dependent error correction coding.

### BACKGROUND

In wireless communications, channel conditions are constantly changing at both fast and slow scale due to, for example, fading effects. Accordingly, channel coding has conventionally always been designed to adapt to channel conditions. Modulation coding scheme (MCS) adaptation, in which the modulation order and code length and code rate can be changed in real time, is a powerful approach to combat varying channel conditions.

Adapting to channel conditions requires channel coding that can flexibly change code length and code rate in a fine-grained way, and at the same time achieve good error correction performance in all possible configurations. This fine-grained flexibility of channel codes remains a challenge.

Probabilistic codes such as low density parity check (LDPC) codes, which are more like random codes, may be naturally suited for flexibility. However, algebraic codes such as Reed-Muller (RM) codes and Bose-Chaudhuri-Hocquenghem (BCH) codes, are not as flexible as probabilistic codes. This is because their inherent coding structures may be compromised when code length or rate changes. Polar codes exhibit features from both probabilistic codes and algebraic codes. As a result, polar codes have a level of flexibility that lies between probabilistic codes and algebraic codes.

Rate matching, including techniques such as puncturing and shortening, is available to design rate-compatible polar codes, such as the polar codes for fifth generation (5G) new radio (NR). However, the degree of flexibility is not enough to support more advanced features such as fine-grained incremental-redundancy hybrid automatic repeat request (IR-HARQ), for example.

A more flexible channel coding approach is needed.

### SUMMARY

The present disclosure encompasses embodiments related to enabling or facilitating what is referred to herein primarily as channel-dependent error correction coding, which may involve a new coding structure that allows codes, even after code construction and encoding, to have multiple decoding options for different channel conditions.

According to an aspect of the present disclosure, a method involves encoding input bits to obtain blocks of encoded bits, and outputting the blocks of encoded bits. Each of the blocks of encoded bits has a respective associated code rate and a respective associated capacity. The blocks of encoded bits include nested blocks. Each nested block includes a subcode of another one of the blocks of encoded bits that has a higher respective associated code rate than the nested block. The nested blocks include coupled blocks that are coupled to each other.

Another method involves receiving blocks of encoded bits obtained by encoding input bits, and decoding the encoded bits to obtain decoded input bits. Each of the blocks of encoded bits has a respective associated code rate and a respective associated capacity, the blocks of encoded bits include nested blocks, each nested block includes a subcode of another one of the blocks of encoded bits that has a higher respective associated code rate than the nested block, and the nested blocks include coupled blocks that are coupled to each other.

An apparatus according to an embodiment includes an encoder and an interface coupled to the encoder. The encoder is for encoding input bits to obtain blocks of encoded bits, and the interface is for outputting the blocks of encoded bits.

According to another embodiment, an apparatus includes an interface and a decoder coupled to the interface. The interface is for or receiving blocks of encoded bits obtained by encoding input bits, and the decoder is for decoding the encoded bits to obtain decoded input bits.

In apparatus embodiments, and others, each of the blocks of encoded bits has a respective associated code rate and a respective associated capacity, the blocks of encoded bits include nested blocks, each nested block includes a subcode of another one of the blocks of encoded bits that has a higher respective associated code rate than the nested block, and the nested blocks include coupled blocks that are coupled to each other.

In other apparatus embodiments, an apparatus may include a processor configured to cause the apparatus to perform any of the methods as disclosed herein.

An apparatus may include a processor and a non-transitory computer readable storage medium that is coupled to the processor and stores programming for execution by the processor.

A storage medium need not necessarily or only be implemented in or in conjunction with such an apparatus. A computer program product, for example, may be or include a non-transitory computer readable medium storing programming for execution by a processor.

Programming stored by a computer readable storage medium may include instructions to, or to cause a processor to, perform, implement, support, or enable any of the methods disclosed herein.

A system is also disclosed, and may include a first communication device and a second communication device. The first communication device is configured to transmit blocks of encoded bits obtained by encoding input bits. The second communication device is configured to receive the blocks of encoded bits, and to decode the encoded bits to obtain decoded input bits. As in other embodiments, each of the blocks of encoded bits has a respective associated code rate and a respective associated capacity, the blocks of encoded bits include nested blocks, each nested block includes a subcode of another one of the blocks of encoded bits that has a higher respective associated code rate than the nested block, and the nested blocks include coupled blocks that are coupled to each other.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 illustrates an example protograph matrix.

FIG. 6 is a trellis graph illustrating an example of a polar code.

FIG. 7 is a trellis graph illustrating distributions of log-likelihood ratios (LLRs) in polar code decoding.

FIG. 8 is a diagram illustrating decoding of a capacity-sufficient block before decoding a capacity-deficient block.

FIG. 9 is a block diagram comparison of channel-independent codes and channel-dependent codes.

FIG. 10 illustrates an example factor graph of a code.

FIG. 11 illustrates an example of a nested code structure.

FIG. 12 illustrates an example of information bit mapping according to an embodiment.

FIG. 13 illustrates another example factor graph.

FIG. 14 illustrates an example of check node coupling between variable rate blocks.

FIG. 15A is a diagram illustrating bit value placement on bit indices according to an embodiment.

FIG. 15B is a diagram illustrating example bit index to label mappings.

FIG. 15C is a diagram illustrating bit value placement on bit indices, using bit labeling according to an embodiment.

FIG. 16 is a block diagram illustrating an f-function used in polar code decoding.

FIG. 17 is a block diagram illustrating a g-function used in polar code decoding.

FIG. 18 is a diagram illustrating processing of a “butterfly” in polar code decoding.

FIG. 19 is a diagram illustrating a binary tree representation of successive cancellation decoding.

FIG. 20 is a block diagram illustrating a binary tree representation of SC decoding of a length N=4 polar code.

FIG. 21 is a block diagram illustrating a gᵣ-function used in an embodiment of non-sequential polar code decoding.

FIG. 22 is a block diagram illustrating an fᵣ-function used in an embodiment of non-sequential polar code decoding.

FIG. 23 is a diagram illustrating processing of a “butterfly” in an embodiment of non-sequential polar code decoding.

FIG. 24 is a diagram illustrating a binary tree representation of an example of decoding scheduling.

FIG. 25 is a diagram illustrating a binary tree representation of non-sequential SC decoding of a length N=4 polar code.

FIG. 26 includes a table and a diagram of a trellis, illustrating differences between non-sequential and sequential decoding.

FIG. 27 is a diagram of a trellis, illustrating an example of decoding that involves non-sequential polar code decoding.

FIG. 28 is a diagram of a trellis, illustrating another example of decoding that involves non-sequential polar code decoding.

FIG. 29 is a diagram of a trellis, illustrating a further example of decoding that involves non-sequential polar code decoding.

FIG. 30 is a diagram of a trellis, illustrating yet another example of decoding that involves non-sequential polar code decoding.

FIG. 31 is a diagram of a trellis, illustrating a bidirectional decoding example.

FIG. 32 is a diagram of a trellis, illustrating another bidirectional decoding example.

FIG. 33 illustrates coding with block coupling according to an embodiment.

FIG. 34 illustrates coding with block coupling according to another embodiment.

FIG. 35 is a flow diagram illustrating more general example methods according to embodiments.

FIG. 36 is a block diagram illustrating an apparatus according to an embodiment.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

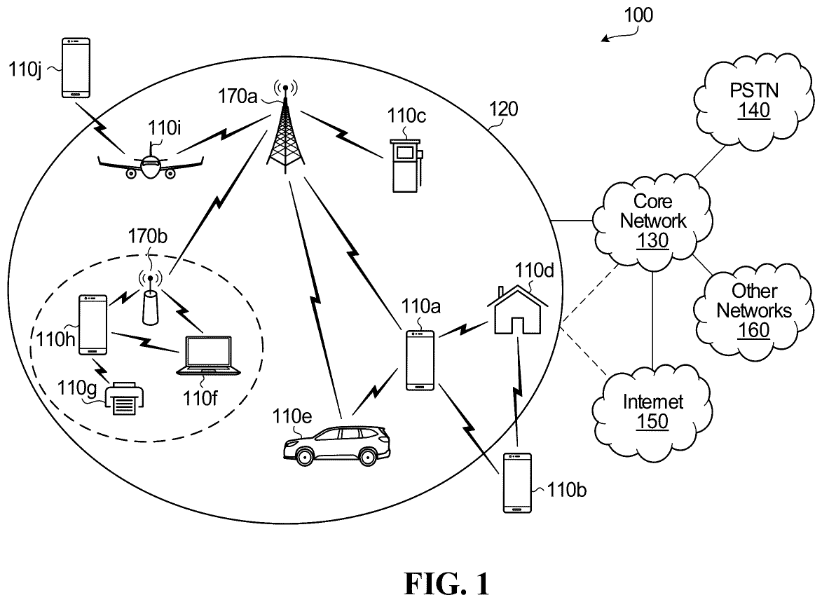

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

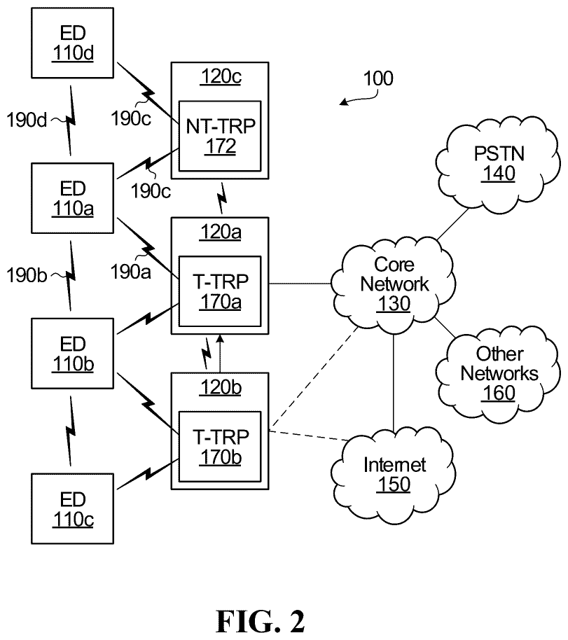

FIG. 2 illustrates an example communication system 100. In general, the communication system 100 enables multiple wireless or wired elements to communicate data and other content. The purpose of the communication system 100 may be to provide content, such as voice, data, video, signaling, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), Direct Fourier Transform spread OFDMA (DFT-OFDMA) or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

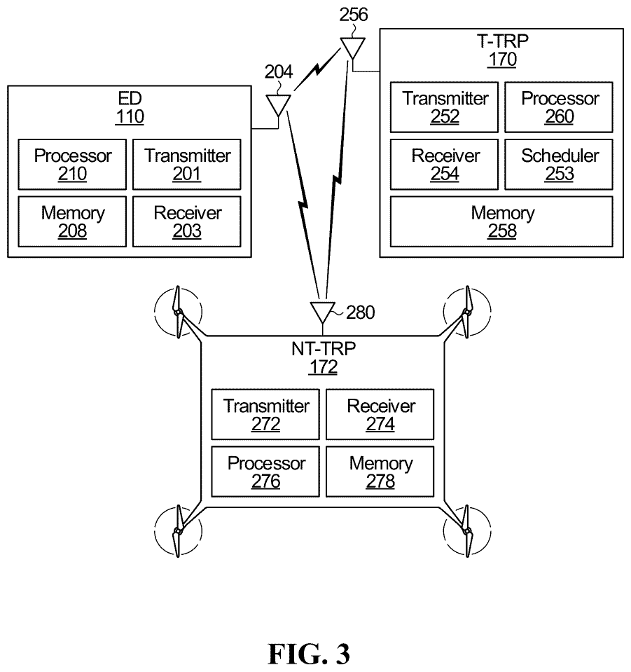

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices such as a watch, head mounted equipment, a pair of glasses, an industrial device, or apparatus (e.g., communication module, modem, or chip) in the foregoing devices, among other possibilities. Future generation EDs 110 may be referred to using other terms. Each base station 170a and 170b is a T-TRP and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., in the memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), a Central Processing Unit (CPU) or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the foregoing devices or refer to apparatus (e.g., a communication module, a modem or a chip) in the foregoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU, a CPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

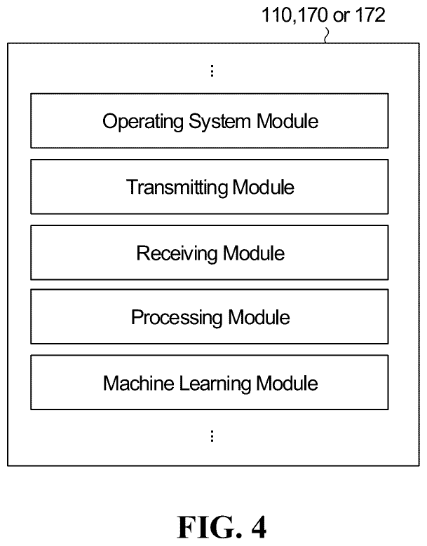

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or by a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, a CPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Having considered communications more generally above, attention will now turn to particular example embodiments.

Channel coding deals with the uncertainty incurred when signals travel through noisy channels. Channel condition as used herein can refer to any of channel gain/fading, additive noise and interference. Channel-independent coding design means code construction, encoding and decoding are independent from the specific channel conditions. Channel-dependent coding design means either (or more than one) of the code construction, encoding and decoding schemes is aware of the specific channel conditions, and is designed or executed accordingly.

An LDPC code is defined by its parity check matrix, commonly denoted by H. Each row in H represents a parity-check function, where positions of “1” values correspond to code bits that engage in the parity check function. For example, a row [1, 0, 0, 1, 0, 1] means that an exclusive or (XOR) of the 1^{st}, 4^{th}, and 6^{th} code bits has to be 0 to pass the parity check function.

A codeword c is generated such that it passes all the parity checks defined by the rows of H, or H·c=0.

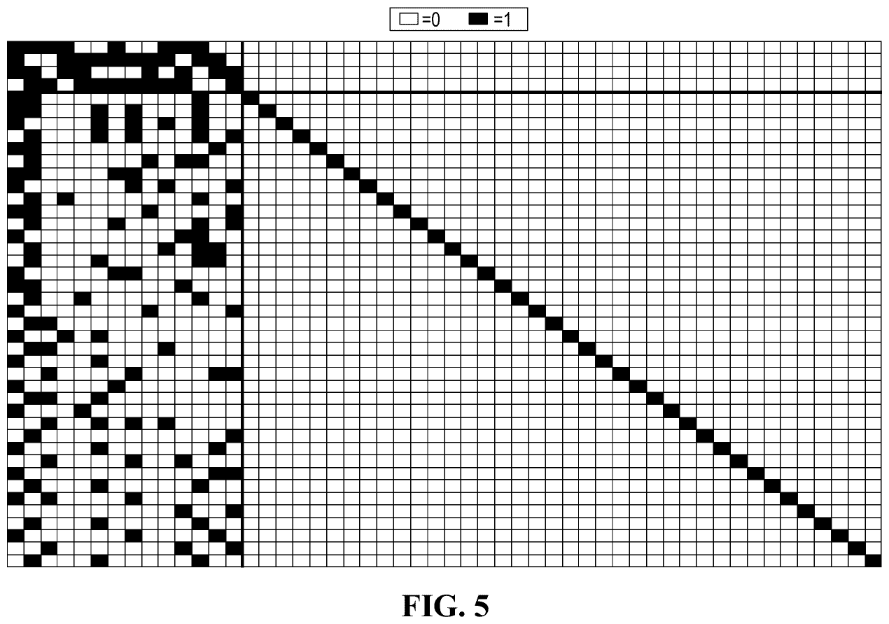

The parity-check matrix has far more 0s than 1s, making it “low density”. In 5G, a protograph-based quasi-cyclic LDPC code design is adopted, where the parity-check matrix is generated in two steps:
1. Read out a pre-defined protograph matrix (FIG. 5 illustrates an example protograph matrix);
2. Replace each “1” in the protograph matrix by a circular shifted identity matrix, or a “circulant”, using a pre-defined shifting value for each “1” position. This step is called “lifting”. The resulting lifted matrix is the final parity-check matrix for LDPC codes.

Currently, this type of LDPC design is simple and works for a wide range of code rates and length. For example:
for higher code rates, fewer rows in the protograph may be used, and for lower code rates, more rows in the protograph (more parity checks) may be used;
for longer codes, the protograph may be lifted with a larger circulant, and for shorter codes, the protograph may be lifted with a smaller circulant.

Accordingly, LDPC codes can be very flexible and thus are suitable for wireless communications. With MCS adaptation, LDPC codes can adapt to dynamic wireless channel conditions from packet to packet. However, current LDPC designs as referenced above are still channel independent, which means that they cannot adapt to any dynamic channel change within a packet (codeword).

Successive cancellation (SC) is the basic decoding algorithm for polar codes, according to which all frozen bits and information bits are decoded sequentially, bit by bit. Preceding bits are always decoded first, before decoding a current bit.

Successive cancellation list (SCL) is an enhanced decoding algorithm for polar codes, where multiple (L) SC decoding instances are executed. Each instance is called a “decoding path”. When decoding each binary bit, both “0” and “1” branches are extended to each path, creating 2L paths. Then, all 2L paths are compared, where the most likely L paths are kept, and the least likely L paths are discarded (or pruned). The path extension and pruning operations are performed during decoding every information bit, until all information bits are decoded. At last, the most likely path is selected as the decoding output.

CRC-aided successive cancellation list (CA-SCL) decoding works similarly to SCL, except that in the last step, the most likely path that passes CRC check is selected as the decoding output.

Parity-check successive cancellation list (PC-SCL) decoding also works similarly to SCL, except that when decoding parity-check (PC) bits, the parity check value of associated preceding bits is used as a bit decision result. PC bits are in addition to frozen bits and information bits.

Polar codes are linear block codes. For a polar code of length N, its generator matrix is G_{N}, and its encoding process is

$${x}_{1}^{N} = {u}_{1}^{N} {G}_{N} , where {u}_{1}^{N} = [ {u}_{1} , {u}_{2} , … , {u}_{N} ]$$

is a binary input vector, and

$${x}_{1}^{N} = [ {x}_{1} , {x}_{2} , … , {x}_{N} ]$$

is the binary code vector. The N×N binary generator matrix

$${G}_{N} = {F}_{2}^{⊗ n} , where {F}_{2} = [ \begin{matrix}1 & 0 \\ 1 & 1\end{matrix} ]$$

is the polarization kernel matrix, ⊗ is Kronecker product, and n=log₂ N.

With K information bits to be encoded into N code bits and K<N, a code rate of R=K/N<1 is obtained. This implies only part of u₁^{N} is used to carry information bits, and the remining bits of u₁^{N} are known as frozen bits. The information bit set (or information set) may be denoted by I, and the frozen bit set (or frozen set) may be denoted by F. Sometimes, there is an additional PC bit set, denoted by P. The frozen bits are known and usually set to all zeros before decoding, so they do not carry any information. The PC bits are parity-check bits of a subset of information bits, and therefore are known once the associated information bits are decoded. Decoding of polar codes attempts to recover all information bits.

Code length M may, but might not always, be a power of 2, in which case M<N. In practice, puncturing and shortening are used to reduce the number of transmitted code bits from N to M. For convenience, N is referred to as mother code length, and M is referred to as code length herein. In particular, punctured bits are untransmitted bits (i.e., bits of the mother code length that are not transmitted) that are unknown to a decoder, but shortened bits are untransmitted bits that are known to the decoder (usually all zeros).

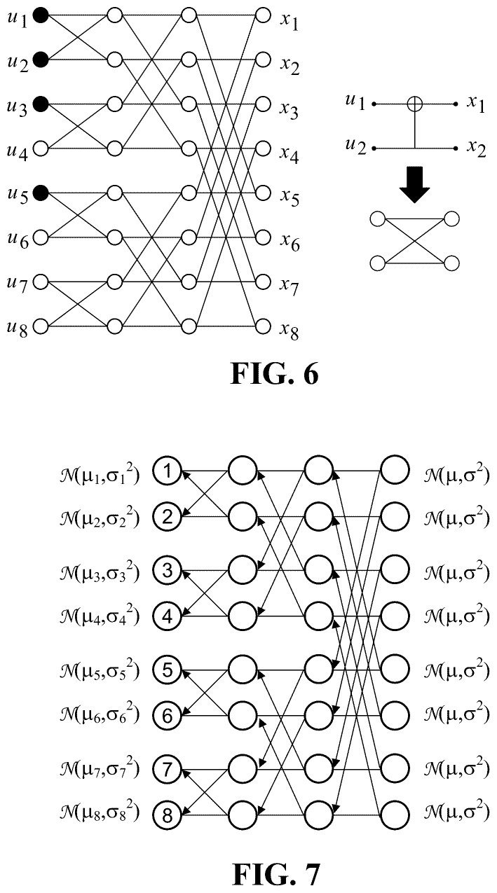

FIG. 6 is a trellis graph illustrating an example of a polar code with N=8 and K=4. Each “butterfly” in the graph is a polarization, and one butterfly is shown by way of example at the right in FIG. 6, for

$${x}_{1}^{2} = {u}_{1}^{2} [ \begin{matrix}1 & 0 \\ 1 & 1\end{matrix} ] .$$

in the example shown, the unshaded circles at the left represent the information set I={u₄, u₆, u₇, u₈}, and the shaded circles represent the frozen set F={u₁, u₂, u₃, u₅}.

The input vector u at the left in FIG. 6 and the code vector x at the right in FIG. 6 each include a number of bit positions. The bit positions in the input vector are indexed by respective bit indices, and bit values are placed on or at those bit indices or bit positions for encoding. These bit indices or bit positions are also sometimes referred to as bit channels or subchannels. Placing bit values on bit indices as disclosed herein may also be referred to in other ways, such as placing bits or bit values on or at bit indices, bit positions, bit channels, or subchannels; or assigning bit values or bits to bit indices, bit positions, bit channels, or subchannels. Other terminology may be used to express how bit values or bits are provided as inputs to encoding. The present disclosure refers primarily to placement of bit values on bit indices, but other terminology may equivalently be used to convey the same concept.

In this way, a polar code may be considered as providing or comprising bit indices, bit positions, bit channels, or subchannels for bit values. Those bit indices, bit positions, bit channels, or subchannels are not necessarily only for bits that are to be encoded. For example, the u vector elements u₁, . . . u_{N} are also referenced in decoding, and therefore bit values that are decoded may similarly be associated with bit indices, bit positions, bit channels, or subchannels.

On the right side in FIG. 6, the code vector x also includes a number of elements that are in or at bit positions or bit indices. A bit value on the i-th bit index in the input vector u has some effect on multiple code bits in the code vector x, but the bit value on the i-th bit index in the input vector u is the primary contributor to the value of the code bit on the corresponding i-th bit index in the code vector x. In this sense, for a polar code, input vector bit indices or bit positions may be considered to correspond to, or be associated with or related to, code vector bit indices or bit positions. This is the case for polar codes, and there may be different input/code bit correspondence, relationships, or associations for other types of codes.

Regarding encoding, the process of encoding may be expressed in any of various ways. For example, encoding may be described as encoding bits to obtain encoded bits or to generate encoded bits. The above-referenced encoding process

$${x}_{1}^{N} = {u}_{1}^{N} {G}_{N} ,$$

for example, may be expressed as generating or otherwise obtaining an encoding input (the input vector u in this example) that includes bits or bit values for encoding, to obtain or generate a number of encoded bits (the code vector x in this example).

The bit values of elements in the input vector u, from an encoding perspective, may be referred to as values or bits to be encoded, or as values or bits for encoding, for example. Blocks of bits or bit values for encoding are also sometimes referred to as code blocks. The bit values of elements in the code vector x may be referred to as encoded bits, coded bits, or code bits, and a block of such bits may be referred to as a codeword, for example.

From a decoding perspective, decoding may be referred to as decoding encoded bits, a codeword, or a code, or as decoding, obtaining, or recovering bits or bit values (that were encoded), from the encoded bits, a codeword, or a code, for example. The bit values of elements in the vector u, in the context of decoding, may be referred to as decoded or recovered bits or bit values.

Polar codes are typically decoded by successive cancellation (SC) and its variants. Currently, SC-based polar decoders follow a sequential order while performing successive cancellation. With information, frozen, and parity check (PC) bit positions denoted by

$$u {}_{1}^{N} = [ {u}_{1} , {u}_{2} , … , {u}_{N} ] ,$$

then the decoding order is u₁, u₂, . . . , u_{N}.

FIG. 7 is a trellis graph illustrating distributions of log-likelihood ratios (LLRs) in polar code decoding. Under sequential SC decoding, the distribution of LLR (u₁, u₂, . . . , u_{N}) (leftmost column in the graph in FIG. 7) can be derived from the distribution of LLR (x₁, x₂, . . . , x_{N}) (rightmost column in the graph in FIG. 7).

Polar codes are therefore channel-dependent codes. In Arikan, Erdal. “Channel polarization: A method for constructing capacity-achieving codes for symmetric binary-input memoryless channels.” IEEE Transactions on information Theory 55, no. 7 (2009): 3051-3073, it is stated that “polar codes are channel-specific designs: a polar code for one channel may not be a polar code for another”. However, such channel-dependent design of polar codes is static. This means that once a polar code is constructed, it already assumes a specific, and fixed, channel realization. The receiver cannot adapt to any varying channel conditions.

Channel-independent channel coding design has two major disadvantages:

In the case of imperfect channel estimation under varying channel condition, channel-independent channel coding design does not allow the transceiver to adapt to true channel condition.

The channel-independent channel coding has a limited coding structure.

A technical problem that is considered herein relates to how to construct, encode and decode channel-dependent error correction codes. Acquiring channel-dependent codes may involve a new coding structure that allows codes, even after code construction and encoding, to have multiple decoding options for different channel conditions.

One observation of channel coding is the relation between rate and capacity. When code length approaches infinity, error-free communication is unlikely when rate is higher than capacity. With finite-length coding, it is still possible to correctly decode when the rate is larger than capacity. However, the error rate will significantly increase.

A codeword can be divided into several shorter (sub)-blocks, and each block has:
a respective block capacity, which is the sum or total bit channel capacity of the corresponding code bits of the block, depending on the channel and code length;
a respective block code rate, which is the ratio between the number of unknown bits and block length.

In some embodiments herein, the respective block code rate, also referred to as blockwise code rate, is not fixed. The block or blockwise code rate of a block may be dependent on decoding order, for example. There may be a maximum code rate and/or a minimum code rate, but otherwise a block or blockwise code rate need not be fixed.

When block capacity is higher than block code rate of a block, the block may be called a “capacity-sufficient block”. When block capacity is lower than block code rate of a block, the block may be called a “capacity-deficient block”. For good error correction performance, a rule of thumb or default decoding order may be to decode capacity-sufficient blocks first, and then decode capacity-deficient blocks.

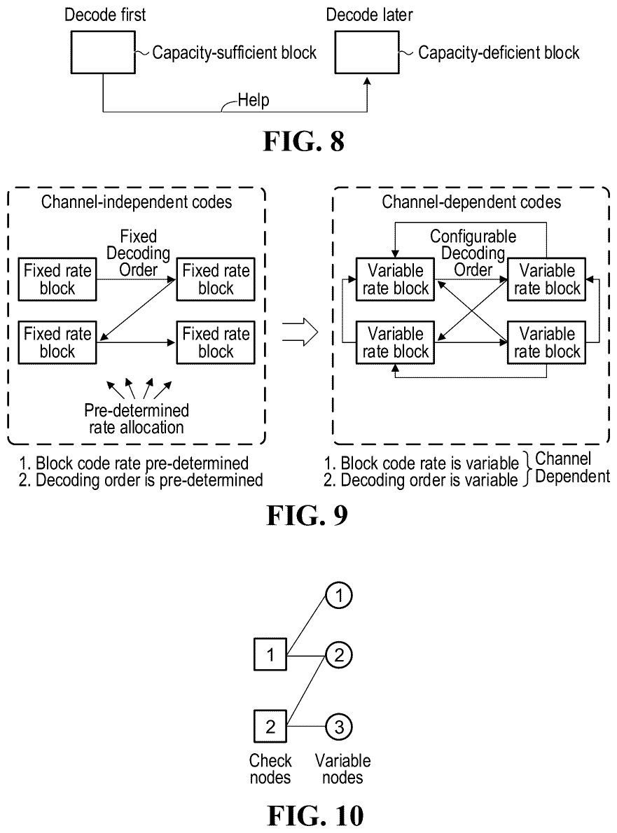

FIG. 8 is a diagram illustrating decoding of a capacity-sufficient block before decoding a capacity-deficient block. The arrow labelled “Help” in FIG. 8 is intended to illustrate that decoding of one block of a codeword may help decoding of another block of the codeword, as discussed in further detail herein.

FIG. 9 is a block diagram comparison of channel-independent codes and channel-dependent codes, and provides an overview of proposed channel-dependent coding structure consistent with the present disclosure.

Several features of channel-dependent codes are worthy of note in FIG. 9, and represent key points in some embodiments of the present disclosure. These include:

Flexible decoding order. The decoder has many options in deciding which block to decode first, and the subsequent decoding order. Decoding can be block-by-block, or transitioning (“jumping”) between blocks. Flexible decoding order may also or instead be referred to as configurable decoding order, as in FIG. 9, and is shown in FIG. 9 by the inner arrows between the blocks.

Variable-code-rate blocks. Each block, when looked at in different subspaces, can have variable code rate, depending on decoding of other blocks as discussed in further detail elsewhere herein. Length of any variable-code-rate block does not change, but code rate can change as other blocks are decoded.

Block coupling. Multiple blocks, and potentially all blocks as shown by the outer arrows in FIG. 9, are coupled to another block. Each block at the right in FIG. 9 is coupled to one other block in the example shown, but other embodiments may also include one or more blocks that are not coupled to any other block. Block coupling is in order to allow mutual information flow from one block to another during decoding. There are many ways of coupling blocks to each other, and illustrative examples are provided elsewhere herein.

Transmission or output order. In the case of variable-length blocks, code bits may be transmitted or otherwise output in a particular order that is intended to provide balanced performance at different lengths. For example, when there are multiple blocks, it may be preferable to transmit or output the code bits corresponding to the most capacity-sufficient block first. Transmission or output order from an encoder or encoding device may be known to a decoder or decoding device, and decoding order may be the same as the transmission or output order under static channel conditions based upon which transmission or output order was determined. However, in some embodiments decoding can still take advantage of, or otherwise be dependent upon, dynamic channel conditions by using a different decoding order to decode blocks in an order that is different from the order in which the blocks were transmitted or otherwise output (and received or otherwise obtained or provided for decoding).

These features are not necessarily tied to any specific codes or types of codes, such as LDPC codes or polar codes, but may also or instead be applied to a wide range of codes, including any of the following examples: algebraic codes, convolutional codes, polar codes, and probabilistic codes (e.g., turbo codes and LDPC codes).

Regarding flexible decoding order, the decoding order of multiple blocks, and the code bits within each block, is not pre-determined in embodiments disclosed herein, but rather can adapt to varying channel condition.

The decoding order can be determined, for example, based on a blockwise rate-to-capacity ratio. The rate in this context may be a ratio between the number of unknown bits and block length, and can be considered a form of code rate. As more code bits are decoded in a block, the rate can change during the course of decoding. The capacity in this context may be the sum of capacity, such as bit channel capacity, of the corresponding code bits in that block. As other blocks are decoded, mutual information about the block will flow in, and the blockwise capacity will increase accordingly.

As an example, with this definition of blockwise rate-to-capacity ratio, decoding order may be as follows in some embodiments:
decode the block with the smallest rate-to-capacity ratio;
update the rate-to-capacity ratio of each block during decoding (because they will change, at least in the case of coupled blocks).

Decoding order may be represented in any of various ways, including the following four examples of ways to represent decoding order:
a sequence including or consisting of the indices of variable nodes;
a sequence including or consisting of indices of check nodes;
a sequence including or consisting of indices of the blocks;
a sequence including or consisting of indices of transition points or “jumping” points between two blocks, where a decoding operation transitions between the blocks.

Check nodes and variable nodes may be defined on a factor graph representation of a code. FIG. 10 illustrates an example factor graph, which includes two check nodes at the left and three variable nodes at the right.

Regarding variable-code-rate blocks, to adapt to varying channel condition, blocks have variable code rate in some embodiments. Specifically, although a codeword block has been constructed and encoded, and has a fixed length, different subspaces of the code space can have different code rates. By definition, a subcode is a subset of the codewords of a supercode.

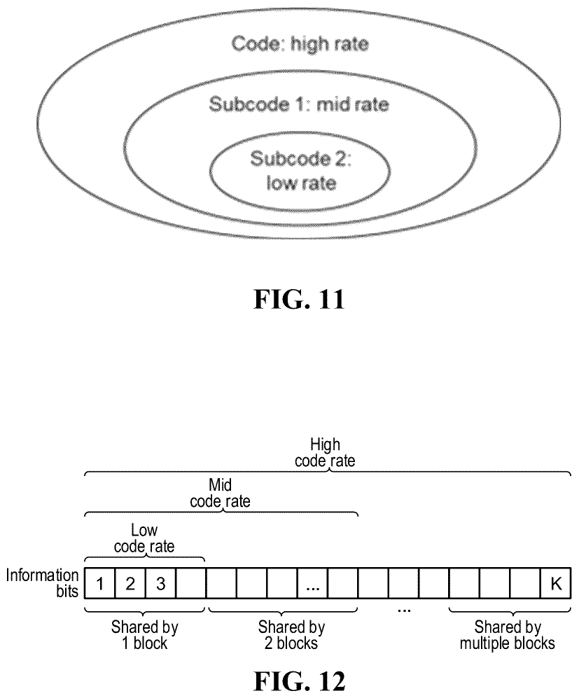

FIG. 11 illustrates an example of a nested code structure. In the nested structure of a codeword block, a low-rate code is a subcode of a high-rate code of the same length. In practice, BCH codes, polar codes, and LDPC codes all can be constructed as variable-code-rate blocks using nested blocks.

To construct variable-code-rate codes, specific information bit mapping methods may be designed and used for encoding and decoding. For example, in order to facilitate flow of mutual information between blocks, some information bits may be shared among multiple blocks. For a variable-code-rate code, there may be high-rate, mid-rate, and low-rate subcodes that have their respective corresponding information bit sets, where the information bits of the low-rate subcode is a subset of the information bits of the high-rate subcode. The information bits of a low-rate subcode can be exclusive for that block, because a low-rate subcode might be more likely to be correctly decoded without mutual information from decoding of other blocks, but the additional information bits of a higher-rate subcode can be shared by multiple blocks. This example is illustrative of a possible general rule according to which, as a subcode (block) rate increases, the additional information bits in that block (and not in a lower rate block) will be shared by more blocks.

An example of information bit mapping according to this mapping method is illustrated in FIG. 12.

The above example information bit mapping method may apply to any of many different types of channel codes, such as BCH codes, polar codes, and LDPC codes.

Regarding block coupling, there are many ways of implementing block coupling. Some implementations may share the same result or essence, but have different representations.

In one general case, any code can be represented by a factor graph, consisting of variable nodes and check nodes.

Variable nodes can be divided into three types:
information variable nodes, which are or represent bits for encoding, which may be referred to as information, systematic, or payload bits;
transmitted or output variable nodes, which are or represent code bits—note some codes involve systematic bits that are information bits but are also transmitted or output;
hidden variable nodes, which are or represent intermediate bits or auxiliary bits during encoding/decoding—these bits are not transmitted or output, and are not information bits.

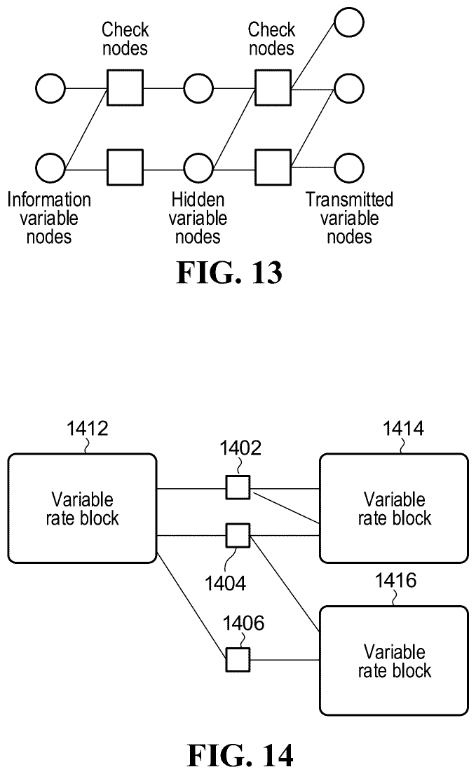

FIG. 13 illustrates another example factor graph, which includes each of these types of variable nodes.

In some embodiments, coupling is between two variable nodes vᵢ, vⱼ, or two sets of variable nodes {vᵢ₁, vᵢ₂, . . . } and {vⱼ₁, vⱼ₂, . . . }. Examples of couplings include the following two types of couplings:
Same value coupling: vᵢ=vⱼ, or {vᵢ₁, vᵢ₂, . . . }={vⱼ₁, vⱼ₂, . . . };
Mapping function coupling: vᵢ=ƒ(vⱼ), or (vᵢ₁, vᵢ₂, . . . )=ƒ(vⱼ₁, vⱼ₂, . . . ), where the function ƒ( ) is pre-determined, and known to both encoder and decoder.

Using variable nodes as the coupling method, coupling examples include the following methods, and their combinations:
Couple Information variable nodes with Information variable nodes;
Couple Information variable nodes with Transmitted or Output variable nodes;
Couple Information variable nodes with Hidden variable nodes;
Couple Transmitted or Output variable nodes with Transmitted or Output variable nodes;
Couple Transmitted or Output variable nodes with Hidden variable nodes;
Couple Hidden variable nodes with Hidden variable nodes;
Using check nodes as the coupling method, coupling examples include the following methods, and their combinations:
Degree d_{c}=2 check node connecting two blocks, where the two connected variable nodes have the same value;
Degree d_{c}>2 check node connecting two blocks;
Degree d_{c}>2 check node connecting more than two blocks.

FIG. 14 illustrates an example of check node coupling between variable rate blocks. The check node 1402 in FIG. 14 is an example of a check node connecting two blocks 1412, 1414 (one variable node in the block 1412 and two variable nodes in the block 1414). The check node 1404 is an example of a check node connecting more than two blocks 1412, 1414, 1416 (one variable node in each of the blocks). The check node 1406 is an example of a check node connecting two blocks 1412, 1416 (one variable node in each of the blocks), and may be the special case of a degree d_{c}=2 check node connecting two blocks where the two connected variable nodes have the same value.

These coupling examples are not mutually exclusive, and may be combined in some embodiments.

Regarding transmission or output order, there are several ways to represent transmission or output order using an ordered sequence, including the following examples:
using a bit (or variable node) index sequence;
using a block index sequence;
using a block index sequence, where a block index may appear more than once (implying or indicating transitions or jumping back and forth between blocks), along with a subset of bit index or bit indices to indicate where to jump out of a block and where to jump into a block.

An ordered sequence may be designed such that the overall difference between blockwise rate and capacity is the smallest, while still locally decodable.

With the general features and procedures described by way of example herein, there is a rich set of codes that can be decoded in a channel-dependent way.

Embodiments disclosed herein may integrate aspects of one or more of the related applications referenced above. For example, some embodiments may integrate features related to non-sequential decoding for polar codes (to provide or support features such as any one or more of flexible decoding order, variable-rate code blocks, or transmission or output order in the case of polar codes for example), or placement of input bit values on multiple bit indices (to provide or support features such as variable-rate code blocks and/or block coupling).

In the present disclosure, embodiments are described by way of example with reference primarily to output by transmitting encoded bits. Outputting encoded bits may involve transmitting encoded bits, or encoded bits that are output may be transmitted, but it should be appreciated that not all embodiments necessarily involve transmitting encoded bits. Features that are disclosed herein in the context of transmitting encoded bits (e.g., from a transmitter) may be applied more generally to outputting encoded bits (e.g., from a logical for physical interface).

Similarly, polar codes are discussed in detail herein as an example, but embodiments are not limited to polar codes or any other type of code. Another detailed is provided below for extended BCH (eBCH) codes.

Considering polar codes, bit index selection and bit value placement may involve a technique that is referred to as labeling. Bit index selection and bit value placement may depend on the number of input bits, also referred to as information length, K. Examples of bit value placement, including labeling in some embodiments, are described in further detail herein, at least below.

Encoding can be performed to obtain a codeword. For example, values of the K information bits are placed on information bit indices, using K labels in some embodiments. The bit value of any input bit may be placed on multiple information bit indices, by assigning the same label to multiple bit indices for example. Therefore, one input bit may in effect be placed on multiple bit indices. In a labeling embodiment, the multiple bit indices are associated with the same label. This may be considered as implicitly establishing a type of check function, where the bit value on a first bit index can be checked by the same bit value that is also placed on one or more other bit indices. Such placement of the same input bit value on two or more bit indices enables the decoded input bit value to be known for all of those bit indices after a bit value is decoded for any one of the bit indices.

As an example, suppose that code length N=32, K=16, bit index selection for the information set is based on reliability, and the most reliable K bit indices in {1 . . . N} are {8, 12, 14, 15, 16, 20, 22, 23, 24, 26, 27, 28, 29, 30, 31, 32}. The information set is then

$$I = \{ 8 , 12 , 14 , 15 , 16 , 17 , 18 , 19 , 20 , 21 , 22 , 23 , 24 , 25 , 26 , 27 , 28 , 29 , 30 , 31 , 32 \} .$$

For bit value placement, in an embodiment the following labels may be used for the 32 bit indices:

$$l = [ o , o , o , o , o , o , o , 5 , o , o , o , 4 , o , 3 , 2 , 1 , 1 , 2 , 3 , 6 , 4 , 7 , 8 , 12 , 5 , 9 , 10 , 13 , 11 , 14 , 15 , 16 ] .$$

Before encoding, the values of the K=16 input bits [a₁, a₂ . . . a₁₆] are assigned to labels 1, 2 . . . 16, respectively, in this example. In particular, with the labels as indicated above, the values of the bits [a₁, a₂, a₃, a₄, a₅], associated with labels 1, 2, 3, 4, 5, respectively, are each placed on two bit indices. The frozen bit indices (with label 0 in the example above) are assigned a value known to the decoder, such as 0. Bit value placement using labels is just one illustrative example of how bit values may be placed on bit indices. The present disclosure is not in any way limited to bit labeling.

The information vector after information/frozen bit value placement on bit indices is as follows:

$$u = [ o , o , o , o , o , o , o , {a}_{5} , o , o , o , {a}_{4} , o , {a}_{3} , {a}_{2} , {a}_{1} , {a}_{1} , {a}_{2} , {a}_{3} , {a}_{6} , {a}_{4} , {a}_{7} , {a}_{8} , {a}_{12} , {a}_{5} , {a}_{9} , {a}_{10} , {a}_{13} , {a}_{11} , {a}_{14} , {a}_{15} , {a}_{16} ] .$$

Encoding is performed by multiplying the information vector u by the polarization matrix, G₃₂ in this example, to obtain the code vector x=u·G₃₂.

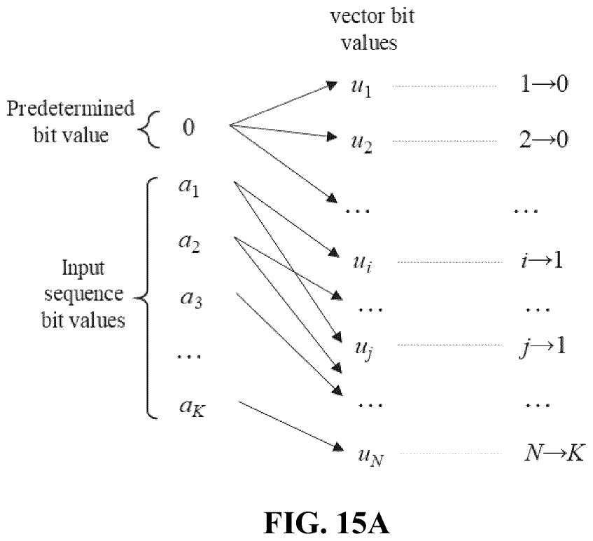

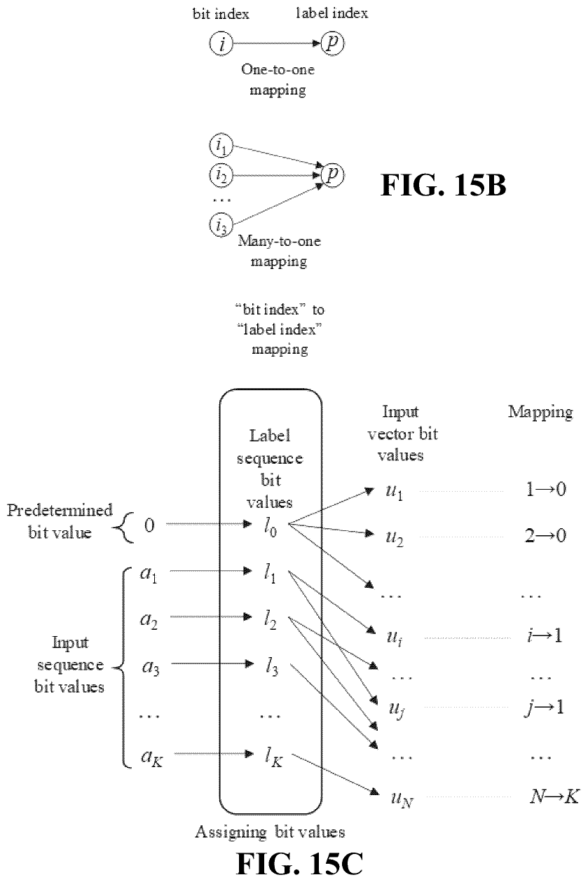

Placement of bit values on bit indices may be implemented or supported in any of various ways, which may or may not involve bit labeling. FIG. 15A is a diagram illustrating bit value placement on bit indices according to one embodiment. Bit value placement may involve or be based on a bit index (or bit position) to bit value mapping, which may also be referred to as a bit value to bit index or bit position mapping, or as a mapping between a bit index or bit position and a bit value. Such a mapping may be either a one-to-one mapping or a many-to-one mapping.

A one-to-one mapping may be defined by or expressed as i→p, where i is a bit index of a bit position, in the input vector shown in FIG. 15A for example, and p is an index of a bit value, in a sequence of bit values such as the input sequence shown in FIG. 15A. For example, an input vector bit u; with a one-to-one mapping to a bit value may be a frozen bit if there is only one frozen bit, or an information bit for an input bit value that is not to be placed on any other bit indices. In this sense the one-to-one mapped information bit is an information bit that is not checked by any other information bit in the input vector. This type of mapping may be referred to as a direct mapping between a bit value and a bit index, in that the mapping does not use a label. The mapping N→K in FIG. 15A is an example of a direct one-to-one mapping.

A many-to-one mapping may be defined by or expressed as {i₁, i₂, i₃ . . . }→p, where i₁, i₂, i₃ . . . are bit indices of bit positions, and p is an index of the bit value to which these bit indices are mapped. For example, the mapping {i, j, k}→p is consistent with a check-type function or relationship uᵢ=uⱼ=uₖ. Among {i, j, k}, if the bit uⱼ is decoded first, then the other bits uᵢ and uₖ take the same decoded value of uⱼ, and in this sense uᵢ and uₖ are information bits but may be considered a form of check bit. A many-to-one bit index to bit value mapping (or one-to-many bit value to bit index mapping) is a direct mapping, between a bit value and multiple bit indices or vice versa. The mappings for input bit values a₁ and a₂ in FIG. 15A are examples of a direct one-to-many or many-to-one mapping.

In FIG. 15A, input sequence bit values include the input bit values (aᵢ). The input bit sequence represents an input block to channel coding, and bit values in that bit sequence are denoted by a₁, a₂, . . . , a_{K}, where K is the number of bits to be encoded. The bit values in the input bit sequence, and a predetermined bit value for frozen bits (0 in the example shown) are placed on bit indices in the binary input vector u₁, u₂, . . . , u_{N}, upon which polar coding is applied, based on the bit index/value mapping shown at the right in FIG. 15A. The arrows between the input sequence bit values and the input vector bit values are intended to represent bit value placement according to which the input vector bit values are set to the input sequence bit values. Placement of a predetermined bit value of 0 for frozen bits is also shown in FIG. 15A for completeness.

The example shown in FIG. 15A illustrates the predetermined frozen bit value 0 and the input bit values a₁, a₂, . . . , a_{K} being placed on bit indices in the binary input vector u₁, u₂, . . . , u_{N}. Using notation introduced above, uᵢ=aₚ if i→p for a one-to-one mapping or { . . . i . . . }=→p for a many-to-one mapping.

Bit value placement of a predetermined value of 0 for all frozen bits and input bit values for a sequence of input bits {1, 2 . . . . K}, can be described by a mapping sequence. With i∈{1, 2 . . . . N} denoting bit indices of bit positions for encoding, and l∈{0, 1 . . . . K} denoting bit value indices for the predetermined value of 0 for frozen bits and input bit values a₁, a₂, . . . , a_{K}, a one-to-one mapping i→p can be denoted by l(uᵢ)=p, a many-to-one mapping {i, j, k}→p can be denoted by l(uᵢ)=l(uⱼ)=l(uₖ)=p, and the mapping sequence can be denoted by l(u₁), l(u₂), . . . , l(u_{N}), where Nis mother code length or a total number of bit indices. For the example shown in FIG. 15A, a mapping sequence may be described as {0, 0, 0, . . . , 1, 2, . . . , 1, 2, 3, . . . , K}.

Bit value placement may involve labels in some embodiments. A bit index (or bit position) to label mapping (which may also be referred to as a label to bit index or bit position mapping, or as a mapping between a bit index or bit position and a label) may, like a bit index/bit value mapping, be either a one-to-one mapping or a many-to-one mapping.

A one-to-one mapping using labels may be defined by or expressed as i→p, where i is a bit index of a bit position as above, but p is an index of a label. For example, an input vector bit uᵢ with a one-to-one mapping to a label may be a frozen bit if there is only one frozen bit, or an information bit that does not share a label with, and in a sense is not checked by, any other information bit.

A many-to-one mapping using labels may be defined by or expressed as {i₁, i₂, i₃ . . . }→p, where i₁, i₂, i₃ . . . are bit indices of bit positions as above, and p is an index of the label to which these bit indices are mapped. For example, the mapping {i, j, k}→p is consistent with a check-type function or relationship uᵢ=uⱼ=uₖ. Among {i, j, k}, if the bit uⱼ is decoded first, then the other bits uᵢ and uₖ take the same decoded value of uⱼ, and in this sense uᵢ and uₖ are information bits but may be considered a form of check bit.

A many-to-one mapping, including direct mapping or mapping using labels, may be used for block coupling in some embodiments, to place the same bit value on multiple bit indices that are associated with code bits in different blocks of a codeword.

FIG. 15B is a block diagram illustrating example bit index to label mappings. In FIG. 15B, bit index to label mapping is represented with bit indices to the left and label indices to the right. The top mapping is a one-to-one mapping and the bottom mapping is a many-to-one mapping. Label mapping is optional, and bit indices may instead be directly mapped to bit values or indices, rather than via labels. Use of label mapping, rather than direct mapping, may be preferable in some embodiments. For example, when described in text in a communication standard or specification, bit values of input bits are not known, and labels may be used to represent the input bit values. As a result, bit mapping and bit value placement may be more conveniently described through the use of labels as a form of reference for the bit values.

FIG. 15C is a block diagram illustrating bit value placement on bit indices, using bit labeling according to an embodiment. In FIG. 15C, input sequence bit values include the input data bit values (aᵢ), and a predetermined bit value of 0 is also illustrated for completeness. Bit values of a label sequence, with individual elements in such a sequence being labels that are placed on bit positions or assigned to bits in an input vector for encoding, are also shown in FIG. 15C. The arrows between the bit values and the label sequence bit values represent both assignment of the labels and setting or assignment of bit values to the labels. The labels include labels that are respectively uniquely assigned to and thereby associated with bit positions in the input sequence, and a frozen bit label as well in the example shown. For encoding a sequence of input bits, the labels are set to the bit values of the input bits. This may equivalently be referred to as the labels being assigned to input bits or input sequence bits (or values), or as the input bits or input sequence bits (or values) being assigned to the labels. The relationship between each one of the K input bits and its assigned label is a unique, in that each input bit has only one uniquely assigned label, and no individual label is assigned to any other input bit. This may be considered another form of one-to-one mapping, between input bit positions (or bits) in an input bit sequence and respective labels.

The input bit sequence in FIG. 15C represents an input block to channel coding, and bit values in that bit sequence are denoted by a₁, a₂, . . . , a_{K}, where K is the number of bits to be encoded. The label sequence is denoted by l₀, l₁, l₂, . . . , l_{K}, where each label l₁, l₂, . . . , l_{K} is associated with an input bit position and input bit that is to be encoded, or with a predefined frozen bit value in the case of label l₀. The predetermined bit value and the bit values in the input bit sequence are placed on bit indices in the binary input vector u₁, u₂, . . . , u_{N}, upon which polar coding is applied, based on the labels and the bit index/label mapping shown at the right in FIG. 15C. The arrows between the label sequence bit values and the input vector bit values are intended to represent both assignment of the labels to input vector bit positions, and bit value placement on bit indices according to which the input vector bit values are set to the predetermined bit value or the input sequence bit values.

In the bit placement examples shown in FIGS. 15A and 15C, (without and with labels, respectively) the predetermined frozen bit value 0 and the input bit values a₁, a₂, . . . , a_{K} are placed on bit indices. With labels, the bit values are assigned as values of the label sequence l₀, l₁, l₂, . . . , l_{K}, where l₀=0 (or any predefined frozen bit value), and lₚ=aₚ for p=1, 2 . . . . K. Then, the bit values 0, a₁, a₂, . . . , a_{K}, optionally having been assigned as bit values to the labels, are placed on bit indices in the binary input vector u₁, u₂, . . . , u_{N}. Using notation introduced above, uᵢ=aₚ (or lₚ in a labeling embodiment) if i→p for one-to-one mapping or { . . . i . . . }→p for many-to-one mapping.

A mapping sequence that describes bit value placement may include bit value indices as in preceding examples, or labels in label embodiments. A one-to-one mapping i→p can be denoted by l(uᵢ)=p, a many-to-one mapping {i, j, k}→p can be denoted by l(uᵢ)=l(uⱼ)=l(uₖ)=p, and the mapping sequence can be denoted by l(u₁), l(u₂), . . . , l(u_{N}), where Nis mother code length or a total number of bit indices. For the example shown in FIG. 15C, a mapping sequence may be described as {l₀, l₀, l₀, . . . , l₁, l₂, . . . , l₁, l₂, l₃, . . . , l_{K}}.

A mapping sequence, whether expressed or defined using bit value indices or labels, could be defined in a communication standard or specification, or generated according to a procedure specified by such a standard or specification, for example. Online generation of such a mapping sequence is one possible option.

FIGS. 15A, 15B, and 15C and the foregoing descriptions thereof provide examples of how bit values may be placed on one or more bit indices. Embodiments disclosed herein are not dependent upon any particular approach to bit value placement. For example, embodiments may, but need not necessarily, involve bit labeling.

The present disclosure also encompasses embodiments that may support non-sequential decoding.

Polar codes are conventionally decoded by SC and its variants. Conventionally, all SC-based polar decoders follow sequential order of bits while performing successive cancellation. With

$${u}_{1}^{N} = [ {u}_{1} , {u}_{2} , … , {u}_{N} ]$$

denoting an input vector that includes information, frozen, and possibly PC bit indices, respectively, the sequential decoding order is u₁, u₂, . . . , u_{N}.

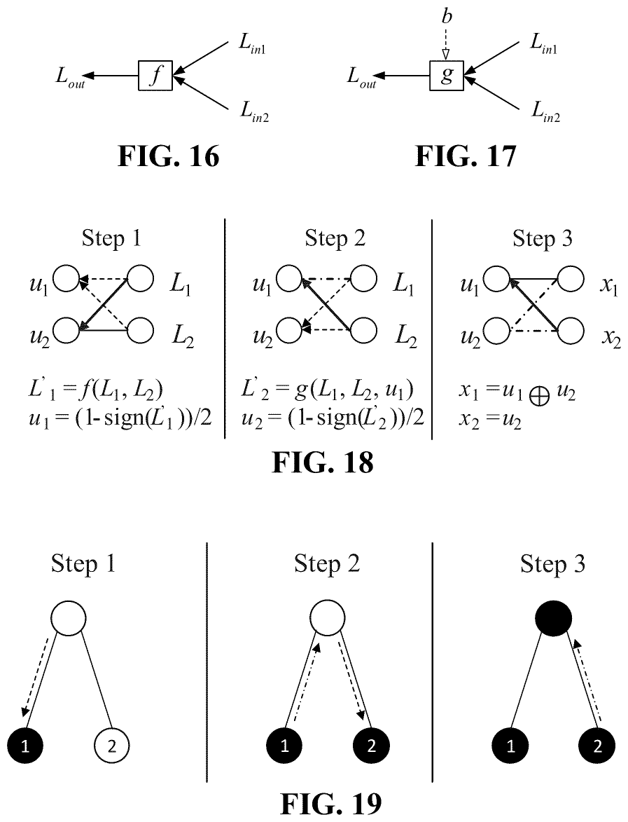

Before a hard decision (i.e., 0 or 1) can be made on a bit value for each information and frozen bit (and PC bit if necessary), received signals corresponding to the code bits are processed in the “butterflies” using the so-called f-function and g-function. The received signals may be known as soft information, which is typically expressed as log-likelihood ratios (LLRs). Soft information is a non-binary value representing the receiver's level of confidence, or probability, of a given bit value being a 0 or a 1. FIG. 16 is a block diagram illustrating the f-function used in polar code decoding and FIG. 17 is a block diagram illustrating the g-function used in polar code decoding.

As shown in FIG. 16, the f-function receives two LLR inputs Lᵢₙ₁ and Lᵢₙ₂, and outputs an LLR Lₒᵤₜ. In a simplified LLR-based algorithm, the f-function is as follows:

$${L}_{o u t} = f ( {L}_{i n 1} , {L}_{i n 2} ) {=}^{△} sign ( {L}_{i n 1} , {L}_{i n 2} ) \cdot min ( \vert {L}_{i n 1} \vert , \vert {L}_{i n 2} \vert )$$

As shown in FIG. 17, the g-function receives three inputs, including two LLRs Lᵢₙ₁, Lᵢₙ₂ and a binary variable b, and outputs an LLR Lₒᵤₜ. In a simplified LLR-based algorithm, the g-function is as follows:

$${L}_{o u t} = g ( {L}_{i n 1} , {L}_{i n 2} , b ) {=}^{△} {L}_{i n 1} + ( 1 - 2 b ) {L}_{i n 2}$$

In the context of SC decoding, it is useful to consider the processing of one single “butterfly”, and FIG. 18 is a block diagram illustrating such processing.

In a first step represented at the left in FIG. 18, the f-function is performed to calculate the LLR of u₁ using the two LLRs on the right side of the butterfly, and this is expressed as L′₁=ƒ(L₁, L₂) in the drawing. If u₁ is an information bit, then its value will be obtained by hard decision, as a value 0 for positive LLR and value 1 for negative LLR, or equivalently, u₁=(1−sign (L′₁))/2, where sign (L) is the sign function. Otherwise if u₁ is a frozen bit or a PC bit, then its value is pre-known (for a frozen bit) or calculated using preceding information bit values (for a PC bit). This applies to all bits from u₁ to u_{N}.

In a second step represented in the middle in FIG. 18, the g-function is performed to calculate the LLR of u₂ using the two LLRs on the right side of the butterfly and the hard decision u₁, expressed as L′₂=g (L₁, L₂, u₁) in the drawing, followed by a hard decision to obtain u₂ based on the calculated LLR. The hard decision is expressed as u₂=(1−sign (L′2))/2 in FIG. 18. As shown, the first bit u₁ is always decoded before the second bit u₂, and more generally each bit is decoded sequentially or in order, from u₁ to u_{N}.

In a third step represented at the right in FIG. 18, with hard decisions on both u₁ and u₂ having been made, it is straightforward to further recover the bits x₁ and x₂ as shown, by x₁=u₁ ⊕u₂ and x₂=u₂. This step is called the “re-encoding” step.

For convenience, a binary tree is often used to simplify the representation of an SC decoder or SC decoding, and FIG. 19 is a block diagram illustrating such a binary tree representation. In a binary tree, a root node at the top of each view in FIG. 19 represents the nodes on the right side of the butterfly (or a trellis), and the leaf nodes at the bottom represent the nodes on the left side of the butterfly (or a trellis). As can be seen, SC decoding becomes a depth-first binary tree traversal.

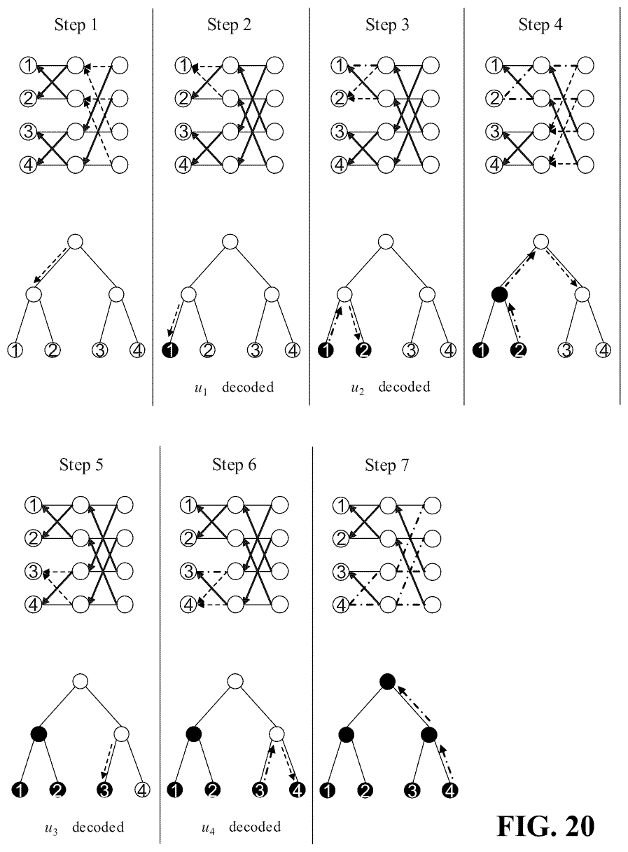

For illustrative purposes, an example of code length N=4 is provided below, and it is believed that decoding of all code lengths can be readily understood based on that example. FIG. 20 is a block diagram illustrating a binary tree representation of SC decoding of a length N=4 polar code.

In FIG. 20, a “butterfly” is represented by a “fork” in the binary tree. Each edge represents either a set of f-functions or a set of g-functions. The order of executing the f/g-function exactly corresponds to the edge traversing order, represented in FIG. 20 by the dashed-line arrows, in the binary tree. After all bits on the left side of a butterfly have been decoded (hard decided), represented by the dot-dash-line arrows in FIG. 20, the bits on the right side of the butterfly will be recovered immediately. Following these rules, the SC decoding of any mother code length N=8, 16, 32, 64 . . . can be derived.

This type of sequential SC decoding order has been used since the introduction of polar codes, and all SC-based decoders such as SCL, CA-SCL and PC-SCL follow the sequential order. Sequential SC-based decoding is believed to be the most common type of decoding for polar codes.

Error propagation can be an issue in SC decoding. When bit decoding order is fixed, a very unreliable information bit can become a bottleneck of an overall code block. For example, if the decision of the i-th bit is incorrect, there is a very high probability that all subsequent information bits with index j>i will be incorrect. In this scenario, if it were possible to avoid decoding the i-th bit first, then there is a much higher probability that the j-th bit will be correctly decoded; however, conventional sequential SC decoding is not capable of avoiding the decoding of the i-th bit to increase the probability of correctly decoding the j-th bit.

SC decoding is also not flexible to channel dynamics. In some polar code implementations such as the NR standard, the probability of successful decoding for each bit (also sometimes referred to as “reliability”) is pre-estimated and specified in the communication standard. In the NR standard, the reliability order is obtained by assuming an Additive White Gaussian Noise (AWGN) channel and is indicated in an ordered sequence in which bit indices are ordered according to their respective reliabilities. The K most reliable bit indices are selected as information bit indices for carrying payload data (also referred to herein as input bits). However, as described herein, channel conditions in wireless communications are constantly changing. As a result, the actual reliability of each bit index may be different from the pre-estimated, fixed reliability specified in the standard. In the case where the actual order of reliabilities (based on actual channel conditions) of given bit indices differs from the specified order of reliabilities, the standardized polar code implementation may not place all information bits into the actual highest reliability bit indices. If the same sequential decoding order is always used as in conventional sequential SC decoding, then the best performance might not be achieved.

Reliability may be considered a measure or indication of how likely it is that a bit value will be correctly decoded or decodable at a decoder. Other related terms or descriptors include capacity, probability or likelihood of error, and probability or likelihood of decoding without error. Reliability is primarily used herein, but features disclosed herein in the context of reliability may also or instead apply in the context of capacity, probability or likelihood of error, probability or likelihood of decoding without error, or other measures or indicators of rank or preference between bit indices for the purpose of placing input bit values for encoding.

Conventional sequential SC decoding also does not support parallel decoding. This is logical because sequential decoding is serial in nature, and all preceding bits have to be decoded before decoding a current bit.

Some embodiments disclosed herein relate to a type of SC decoding, but with arbitrary bit decoding order. For non-sequential decoding, conventional bit decision and LLR updating rules described above no longer apply. New rules and new decoding approaches for non-sequential decoding order are disclosed herein.

Decoding order may have a significant impact on the actual reliability of each bit index. Polarization or reliability as currently defined in communications standards, for example, is fixed and is based on and only holds for conventional sequential decoding. Code construction of polar codes that are appropriate for arbitrary bit decoding order may be based on estimates of actual reliability of each bit index under a new decoding order. The K most reliable bit indices, in terms of estimated actual reliability for non-sequential decoding order, may be different from the most reliable bit indices according to pre-estimated, fixed reliabilities for conventional polar codes (including the 5G polar codes) with conventional sequential SC decoding.

Some embodiments herein involve decoding and decoders. Multiple decoding orders are possible, and this may also be referenced as decoding scheduling. Respective rules and operations for different decoding orders are provided by way of example.

With arbitrary or otherwise flexible decoding order, decoding order or scheduling can be determined based on specific channel conditions.

Non-sequential decoding may be implemented or deployed in conjunction with other features disclosed herein.

Considering the general concept of decoding scheduling, a bit value for any bit, denoted uⱼ for ease of reference, among N bits u₁, u₂, . . . , u_{N} can be decoded without its preceding bit(s), uᵢ|i<j, having been decoded.

For a certain bit uⱼ or a set of consecutive bits, if a hard decision is not to be performed because the capacity of the bit(s) is insufficient for example, then the bit or set of consecutive bits can be skipped. Such skipping of one or more bits, in the context of polar codes, refers to not processing the butterflies associated with that bit or that set of consecutive bits. This means that all associated f-functions, g-functions, LLR updates and re-encoding steps are not performed, or equivalently on a binary tree, if all bits in a subtree are skipped, then that subtree will not be visited for now. Skipped bits may be decoded later when conditions are suitable for decoding, for example when capacity is sufficient.

A general guideline for determining decoding order is to decode a bit at a bit index corresponding to higher capacity (or lower bit error probability) first. For example, there may be many bits or sets of consecutive bits, also referred to herein as blocks of bits, at bit indices with zero or very low capacity. It may be preferable to decode such bits later in a decoding process. Suppose that there are two blocks b1 and b2 with respective blockwise code rates R_{b1} and R_{b2} and respective finite length channel capacities C_{b1} and C_{b2}. If R_{b1}>C_{b1} and R_{b2}<C_{b2}, then it is preferable to decode block b2 before decoding block b1. Here, capacity may be defined differently from existing polar codes, as described in further detail below.

To describe code construction and a corresponding decoding process, a new type of bit is defined and used in some embodiments, in addition to existing frozen bits and information bits. This new type of bit can be given and referenced by any of various names, such as a null bit, an empty bit, a zero-capacity bit, a low-capacity bit, a useless bit, an irrelevant bit, a non-decision bit, an invalid bit, etc. Herein, “null bit” is used simply for ease of reference. It should be appreciated, however, that any of these example names, and/or others, may be used to refer to a bit with such low capacity that it is not to be decoded.

Table 1 below compares existing bit types including information bits and frozen bits to the new bit type, null bit.

TABLE 1
Bit Type Comparisons

| | | | | | Right |
|---|---|---|---|---|---|
| | | | | | propagation |
| | Reliability | | | Bit hard | (re- |
| | or | Value | Value | decision | encoding) |
| | subchannel | before | before | during | during |
| Bit type | capacity | encoding | decoding | decoding | decoding |
| Information | High | Input | Unknown | Decide | Perform |
| bit | | bit value | | based on | |
| | | | | LLR | |
| Frozen bit | Low | Predetermined | Known | Decide | Perform |
| | | bit value | | based on | |
| | | (e.g., 0) | | known | |
| | | | | value | |
| Null bit | Zero | Input | Unknown | Do not | Do not |
| | (or very | bit value | | decide at | perform |
| | low) | | | all | |

Although null bits may have zero-capacity, in some embodiments bits with very low reliability or capacity can be treated as null bits. In the context of bit indices, a set of bit indices for null bits is in addition to an information set, which is a set of bit indices for values of input bits, and a frozen set, which is a set of bit indices for a predetermined bit value.

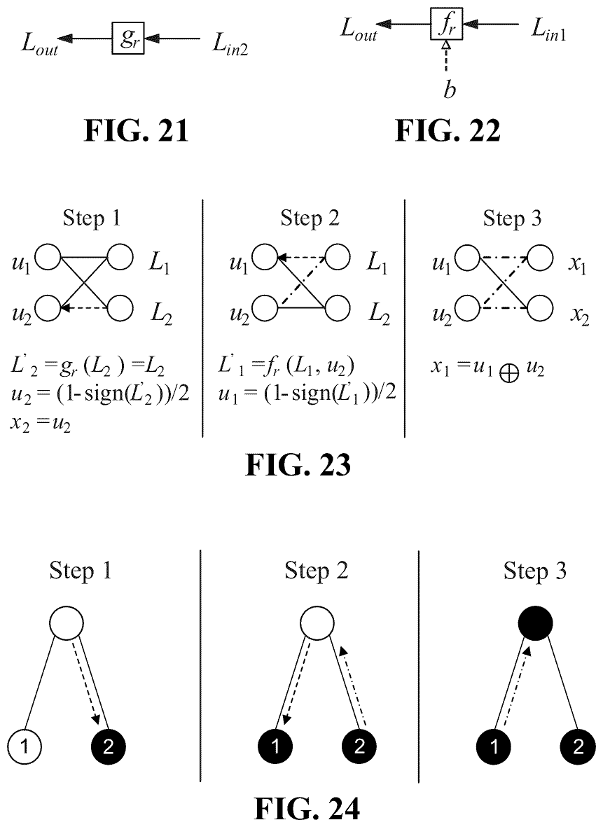

Before a hard decision can be made, received signals corresponding to code bits are processed. Conventional sequential decoding uses two functions, including the f-function and g-function referenced above. Functions or operations in addition to the above-referenced f-function and g-function are disclosed herein and referenced as fᵣ-function and gᵣ-function. These functions are illustrated in block diagram form in FIGS. 21 and 22. FIG. 21 is a block diagram illustrating the gᵣ-function used in an embodiment of non-sequential polar code decoding, and FIG. 22 is a block diagram illustrating the fᵣ-function used in an embodiment of non-sequential polar code decoding.

As shown in FIG. 21, the example gᵣ-function receives an input LLR Lᵢₙ₂, and outputs an LLR Lₒᵤₜ. The gᵣ-function is as follows in some embodiments:

$${L}_{o u t} = {g}_{r} ( {L}_{i n 2} ) {=}^{△} {L}_{i n 2}$$

As shown in FIG. 22, the example fᵣ-function receives two inputs, including an LLR Lᵢₙ₁ and a binary variable b, and outputs an LLR Lₒᵤₜ. The fᵣ-function is as follows in some embodiments:

$${L}_{o u t} = {f}_{r} ( {L}_{i n 1} , b ) {=}^{△} ( 1 - 2 b ) {L}_{i n 1}$$

The examples in FIGS. 21 and 22 are specific to functions in the LLR domain, and are illustrative of functions that may be used in some embodiments. In practice, such functions may be implemented in other domains, such as a probability domain or a likelihood domain. Non-sequential decoding is not in any way limited to the LLR examples for the LLR domain.

More generally, an fᵣ-function has two inputs. A first input is soft information such as a probability value, a likelihood value, or an LLR, and a second input is a binary value. The first input value is associated with the first bit (upper right bit in a butterfly), and the binary value is associated with the second bit (lower right bit in the butterfly). The gᵣ-function has one input, which may be soft information such as a probability value, a likelihood value, or an LLR, associated with the second bit (lower right bit in the butterfly). These functions are different from the conventional functions, in that the conventional f-function has two inputs, and the conventional g-function has three inputs.

The gᵣ-function and the fᵣ-function may be expressed in more general form, in the context of decoding encoded bits in non-sequential decoding order based on the following functions gᵣ and fᵣ:

$${Fn}_{out , g \_ r} = {g}_{r} ( {Fn}_{i n 2} )$$

$${Fn}_{out , f\_r} = {f}_{r} ( {Fn}_{i n 1} , b )$$

where
Fn_{out,g_r} and Fn_{out,f_r} respectively denote outputs associated with each of the functions;
Fnᵢₙ₁ and Fnᵢₙ₂ denote function inputs associated with respective positions (upper right and lower right in a butterfly) in a trellis graph for the polar code; and
b denotes a binary variable associated with the second bit (lower right bit in the butterfly).

In these general forms of the gᵣ-function and the fᵣ-function, the “Fn” function inputs and outputs may be probability values, likelihood values, or LLRs, for example, and the preceding examples illustrate the more specific form of each function in the LLR domain.

Whether to perform the f-function and the g-function, or the new fᵣ-function and the new gᵣ-function, depends on decoding order. With reference to FIG. 23, which is a diagram illustrating processing of a “butterfly” in an embodiment of non-sequential polar code decoding, if the lower-left bit (u₂ in the example shown) in the butterfly is to be decoded first, then the new fᵣ-function and the new gᵣ-function are used instead of the f-function and the g-function. In this example and others herein, LLR domain functions are used for illustrative purposes, but in these and other examples and embodiments, functions in other domains may be used.

In the first step, Step 1 in FIG. 23, the new gᵣ-function is performed to calculate the LLR of u₂ using the LLR on the right side of the butterfly, expressed as L′₂=gᵣ(L₂)=L₂ in the drawing. If u₂ is an information bit, then its value will be obtained by hard decision, of value 0 for positive LLR and value 1 for negative LLR. If u₂ is a frozen bit, then its bit value is already known. As shown, x₂ is equal to u₂, and therefore x₂ can be immediately set to x₂=u₂.

Step 2 in FIG. 23 illustrates a second step, in which the new fᵣ-function is performed to calculate the LLR of u, using the LLR on the right side of the butterfly and the hard decision on u₂, which is expressed in the drawing as L′₁=fᵣ(L₁, u₂), followed by a hard decision to obtain u₁, which is based on the LLR of u₁ if u is an information bit. Note that the decoding order has been changed, in that the second bit u₂ is decoded before the first bit u₁ instead of conventional decoding in sequential order by decoding u₁ before u₂.

In the third step, Step 3, with both u₁ and u₂ decoded, it is straightforward to further recover the code bit x₁ by x₁=u₁⊕u₂. Note that here “re-encoding” is done in both Step 1 (x₂=u₂) and Step 3 (x₁=u₁⊕u₂) in this example. This is also different from sequential decoding.

It should be appreciated that LLR-based calculations or procedures (or similar decoding calculations or procedures) may still be performed for frozen bits and not just for information bits. Although LLRs might not be used in making bit decisions for frozen bits, received LLRs for received code bit indices that correspond to frozen bits may still be used in decoding input bits at bit indices in an information set.

FIG. 24 is a diagram illustrating a binary tree representation of an example of decoding scheduling, and is consistent with the above example that refers to FIG. 23.

Although decoding order may be reversed or otherwise be non-sequential for some bits or blocks of bits, remaining bits or blocks of bits may still follow conventional sequential decoding order. This type of combined decoding order, which may be referred to as hybrid sequential and non-sequential decoding order, may exhibit the best decoding performance.

For example, suppose that decoding order for a length-8 polar code is the following: u₅, u₆, u₇, u₃, u₄, u₁, u₂, u₈. Here, the blocks u₅, u₆, u₇ and u₃, u₄ and u₁, u₂ are sequential within themselves, and these may be referred to as sequential decoding blocks. However, decoding order at the beginning and between the blocks is non-sequential, in that u₅ and not u₁ is decoded first, and between the first two blocks u₅, u₆, u₇ are decoded before u₃, u₄, and between the last two blocks u₃, u₄ are decoded before u₁, u₂. In this example, decoding for u₅ is non-sequential in that u₈ is not decoded immediately after u₇, but in terms of f/g and fᵣ/gᵣ functions, the immediately preceding bit u₇ has already been decoded and therefore conventional f-function and g-function decoding can be used for u₈.

Within any block, decoding may be sequential or may include sequential and non-sequential encoding. For example, in the first block u₅ is decoded first, and this is non-sequential decoding because u₄ was not decoded before u₅. The new fᵣ-function and the new gᵣ-function are used for non-sequential decoding of u₅. Within the first block, however, after u₅ is decoded, sequential decoding (using the f-function and the g-function) can be used to decode u₆ and u₇ because u₅ was decoded before u₆. Decoding then transitions or “jumps” from u₇ to a non-consecutive or non-sequential bit u₃, and decoding of u₃ uses non-sequential decoding. Decoding of u₄ after u₃ is sequential, then non-sequential after transitioning to u₁, and then finally sequential decoding can be used to decode u₂ after u₁. In this example there are three non-sequential transitions, including the initial transition to u₅ and two subsequent transitions at the end of each of the first two blocks. In general, if there are multiple decoding scheduling options with different numbers of such transitions or jumps but the same or similar performance, the option that involves fewer transitions may be preferred.

In embodiments that involve PC bits, the values of the PC bits are either copied from another information bit, or determined from an XOR sum of a set of other information bits. With non-sequential decoding, the definition of PC bits and information bits may depend on decoding order. In general, if PC bits are used, it may be preferred that the last bit in a PC function that is to be decoded according to a decoding order is a PC bit. Once other bits in the PC function have been decoded, the last bit becomes known, presuming that all other bits are correctly decoded.

For example, for a PC function uᵢ+uⱼ=0, if uⱼ is decoded, then uᵢ immediately becomes known because uᵢ=uⱼ. Here, uᵢ, instead of uⱼ, is the PC bit. As another example, for a PC function uᵢ+uⱼ+uₖ=0, if uⱼ and uₖ are decoded, then uᵢ immediately becomes known because uᵢ=uⱼ+uₖ. Here, uⱼ, instead of uₖ, is the PC bit. This is an example of one bit value being placed on multiple bit indices.

Also in the context of PC bits, soft combining can be applied to PC bits. If there are only two undecided bits in a PC function, for example, then they can be jointly decided, such as by combining their soft information such as LLRs. For parallel decoding with uᵢ+uⱼ=0 (or uᵢ+uⱼ=1), for example, and the soft information L′ᵢ and L′ⱼ obtained at the same time, the following can be used

$${u}_{i} = {u}_{j} = ( 1 - sign ( L {}_{i}^{′} + L {}_{j}^{′} ) ) / 2$$

$$or$$

$${u}_{i} = ∼ {u}_{j} = ( 1 - sign ( L {}_{i}^{′} - L {}_{j}^{′} ) ) / 2$$

so that the decisions on uᵢ and uⱼ are done simultaneously. This may be referred to as joint decision or parallel decoding.

For serial decoding and using the same PC function example that was used above for parallel decoding, the difference is that the soft information L′ᵢ is obtained first, and L′ⱼ is to be obtained at a later time. In this case, the hard decision of uᵢ can be postponed until L′ⱼ is obtained. However, a soft decision of uᵢ can be made to allow decoding to continue. Once L′ⱼ is obtained, the hard decisions of uᵢ and uⱼ can be made as in the above parallel decoding example. Decoding order may be determined or obtained based on any of various criteria, such as either or both of code length and channel.

For example, when code length M is a power of 2 (M=N=2ⁿ) sequential decoding may be applied, and sequential decoding may also be applied when code length is (1+α)N/2, where α∈={⅛, ¼, ⅜, ½, ⅝, ¾, ⅞}.

When code length M is over (1+α)N/2, however, where Nis power of 2 mother code length and α∈={0, ⅛, ¼, ⅜, ½, ⅝, ¾, ⅞}, bit indices may be divided into two sets. The two sets include the first (1+α)N/2 bit positions, which may be sequentially decoded, and the other M−(1+α)N/2 bit positions, which may be decoded in non-sequential order.

Other criteria and/or decoding scheduling may be used in other embodiments, and examples are provided elsewhere herein, including at least below.

In some embodiments a scheduling sequence is used to indicate or specify decoding order for all bit indices. Decoding order may be uniquely defined by a scheduling sequence, which may also be referred to as a decoding scheduling sequence or DS. For example, in DS=[i₁, i₂, i₃ . . . i_{M}] the indices i are bit positions to be decoded, and their order in the sequence is the decoding order. As another example, several starting and/or ending points may be used to define a decoding order. Suppose that a scheduling sequence DS=[i₁, . . . , iₜ, iₜ₊₁ . . . i_{M}], includes several sets of consecutive indices represented by “ . . . ”. Such a scheduling sequence can instead be represented as DSₛ=[i₁, iₜ, iₜ₊₁, i_{M}], including only the starting and ending points of each set of consecutive indices.

A scheduling sequence may indicate or specify the order in which decoding for bit indices is to be performed. Decoding sequences may indicate decoding for bit indices in ascending order for sequential decoding, if sequential decoding offers sufficient coding performance for example. In other cases, decoding scheduling sequences might not be in ascending order of bit index, such as for non-sequential decoding.

Scheduling sequences may be determined or designed according to any of various conditions or rules.

For example, an information bit and its preceding consecutive frozen bits may be bundled as an information bit block or cluster. Consecutive bit indices [i, i+1 . . . k−1, k], for example, may be bundled as an information bit cluster if and only if the k-th bit index is an information bit index, and all preceding bit indices [i, i+1 . . . k−1] are frozen bit indices. An information bit cluster with bit indices [i, i+1 . . . k−1, k] may be denoted by {k} for simplicity. Decoding for bit indices in an information bit cluster is sequential in some embodiments. In other words, the decoding order within an information bit cluster is ascending order according to sequential order of the bit indices, and therefore not need be further specified in a scheduling sequence. For convenience, a reference to decoding an information bit cluster {k} is equivalent to decoding for the bit indices [i, i+1 . . . k−1, k] sequentially or in sequential order. With such a description simplification, a decoding sequence can be reduced to include or otherwise indicate only information bit indices.

Non-sequential decoding enables an information bit cluster to be decoded only after the corresponding information bit position at the information bit index of the cluster becomes sufficiently reliable. During the course of decoding, as more information bits are decoded, decoding of bit values for remaining bit indices will become more reliable in general. This phenomenon can be observed for both sequential and non-sequential decoding. Sequential decoding is well known. In non-sequential decoding, decoding for a bit index j, which may involve making a hard decision for an information bit value, can also enhance the decoding reliability for a preceding or smaller information bit index i (i<j). For example, consider an information bit cluster in which the bit value for the last bit index in the cluster has already been decoded from another bit index. In this example, the bit value for the last bit index is known, which makes the preceding bit indices in the cluster more reliable.

If an input bit value is placed on multiple bit indices, with the same label for example, then decoding of a bit value on any one of those bit indices will immediately reveal the bit value on the other bit indices. Therefore, information bit clusters corresponding to the other bit indices may be decoded immediately after the information bit cluster that corresponds to the first decoded bit index. Consider information bit clusters {k₁}, {k₂} and {k₃}, with corresponding information bit indices k₁<k₂<k₃ for illustrative purposes and the same input bit value placed on k₁, k₂, and k₃ using the same label for example. If the information bit cluster {k₃} is decoded first, then {k₁} and {k₂} can be decoded immediately after {k₃}.

Information bit clusters are described above only as an example. Blocks of code bits need not correspond to information bit clusters that include only one information bit and one or more frozen bits. More than one information bit may be decodable from a block of code bits.

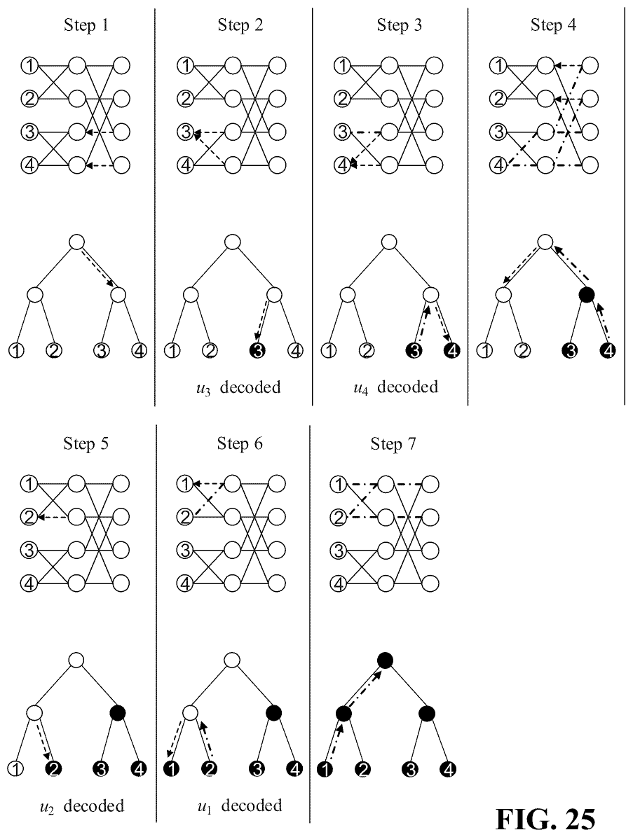

An illustrative and non-limiting example of non-sequential SC decoding is provided below, with reference to FIG. 25, which is a diagram illustrating a binary tree representation of non-sequential SC decoding of a length-4 polar code. The decoding order for the length-4 polar code in this example is u₃, u₄, u₂, u₁.

In FIG. 25, each edge represents either a set of f-functions or a set of g-functions, or a set of fᵣ-functions or a set of gᵣ-functions. The order of executing f/g/fᵣ/gᵣ-function is defined by the decoding order (or scheduling) u₃, u₄, u₂, u₁. Note that the left-to-right hard bit propagation, for u₃ at Step 3, for u₄ at Step 4, for u₂ at Step 6, and for u₁ at Step 7, is done once the lower-left bit in a butterfly has been decoded. In other words, there is no need to wait until both bits on the left side of a butterfly have been decoded (hard decided) to recover the bits on the right side of the butterfly. Following these rules, SC decoding of any mother code length N=8, 16, 32, 64 . . . can be derived given specific decoding scheduling.

Generalizing to SCL decoding, including CA-SCL and PC-SCL:
each path [uᵢ₁, uᵢ₂, . . . , u_{iN}]∈{0, 1}^{N} represents non-sequential SC decoding results, where i₁, i₂, . . . , i_{N}∈{1, 2, . . . , N} are the bit indices;
a path metric is the likelihood (or probability) of the path, given the channel output, which may be expressed as Pr(uᵢ₁, uᵢ₂, . . . , uᵢ|L₁, L₂, . . . , L_{N})—in practice, this may be implemented in the logarithm domain, and approximated as the selected sum of LLRs:

$$PM = {\sum }_{j = i 1}^{i} {e}_{j} \vert L {}_{j}^{′} \vert , where {e}_{j} = \{ \begin{matrix}0 , & if ( 1 - 2 {u}_{j} ) = sign ( L {}_{j}^{′} ) \\ 1 , & if ( 1 - 2 {u}_{j} ) \neq sign ( L {}_{j}^{′} )\end{matrix}$$

is a binary indicator, and L′ⱼ is the LLR of uⱼ.

Decoding may otherwise be the same as sequential SCL decoding.

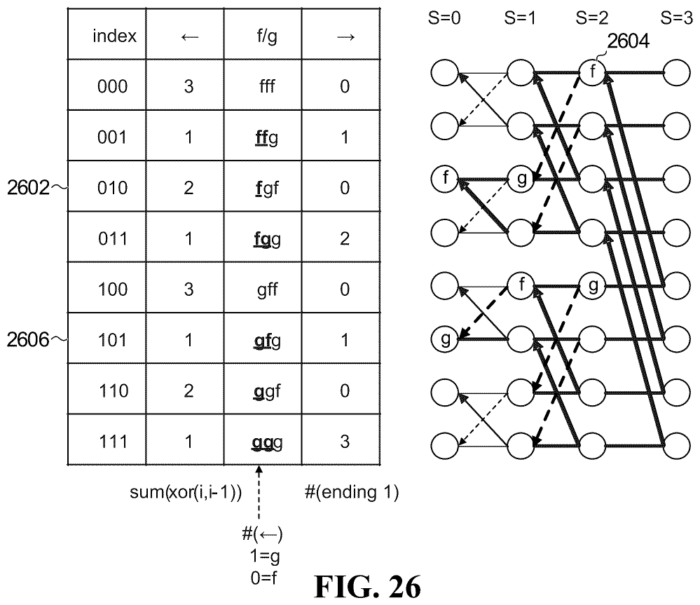

FIG. 26 includes a table and a diagram of a trellis, illustrating differences between non-sequential and sequential decoding. One feature of non-sequential decoding is that decoding may start from any point of the trellis at the right. New left/right propagation features are proposed to support arbitrary starting and finishing bit positions.

Given a bit index i with 0≤i≤N−1 (note here that the index starts from 0 rather than 1), several auxiliary parameters referenced in the example below include the following, all of which are shown at the table on the left in FIG. 26:
Binary expansion of index i: denoted by column label “index” in the table and expressed as bin (i)
Left propagation depth: denoted by column label←in the table and calculated by sum(xor(bin(i), bin(i−1)))
f/g function sequence: denoted by column label “f/g” in the table and expressed as {f, g}ⁿ, where n=log₂(N), and the sequence is obtained by replacing each 0 in bin(i) by an f-function and replacing each 1 in bin (i) by a g-function—note that f/g here is intended to generally denote an f-function or a g function that, depending on decoding order and the bit being decoded, may be the conventional f-function, the fᵣ-function disclosed herein, the conventional g-function, or the gᵣ-function disclosed herein

Right propagation depth: denoted by column label→in the table and calculated by #(ending 1), i.e., the number of ending is in the bin (i).

To decode a bit indexed by i, there are two cases or scenarios.

If the previous bit indexed by i−1 has already been decoded, then the bit indexed by i can be decoded as in sequential decoding because the immediately preceding bit has been decoded. The left propagation depth (the number of stages to perform f/g function) is the second auxiliary parameter above, and the right propagation depth (the number of stages to perform re-encoding) is the fourth auxiliary parameter above.

If the previous bit indexed by i−1 has not yet been decoded, then decoding is non-sequential decoding. The left propagation starts from the rightmost stage, that is, the left propagation depth is n, and the full f/g function sequence is executed. The right propagation depth depends on the decoding status of its subsequent bits. A greedy right propagation of re-encoding is performed as long as there are no XOR operations with a lower bit (in the “butterfly”), or the lower bit is already decoded or re-encoded. As an example, consider starting decoding at index 2 (010), labeled 2602 in FIG. 26. In sequential decoding, an f-function at 2604 in the row of the trellis at S=2 would have been previously executed in decoding the index 0 bit, but for non-sequential decoding in this example this f-function has not been executed because decoding in this example starts with decoding the index 2 bit. Therefore, the f/g function sequence for starting non-sequential decoding at index 2 is shown in the table at the left in FIG. 26 as fgf, with the first f in the f/g function sequence in bold and underline formatting to indicate that non-sequential decoding starting at the index 2 bit involves an f-function that would already have been executed and would need not be repeated in sequential decoding of the index 2 bit after the index 0 and index 1 bits. The trellis at the right in FIG. 26 also includes f/g labeling for another example of non-sequential decoding starting at index 5 (101), labeled 2606 in FIG. 26.

In summary, jumping into decoding a bit in non-sequential order, using LLR domain as an example, may involve propagating LLR (right to left) from a deeper stage (right hand side of the trellis in FIG. 26; propagating hard decisions (left to right) to a deeper stage; and executing the fᵣ-function and the gᵣ-function as needed.

In some embodiments, information/frozen/PC bits are still decoded one by one, but decoding of such bits does not follow a sequential order according to the bit index [1, 2, 3 . . . . N]. Instead, the decoding order is specified by a decoding scheduling sequence DS=[i₁, i₂, i₃ . . . i_{M}], where the indices are the information/frozen/PC bit indices to be decoded. Note that M can be an integer smaller than N, because some zero-capacity or near zero-capacity bit indices can be skipped. This is an example of what may be referred to as “scheduled-serial” decoding.

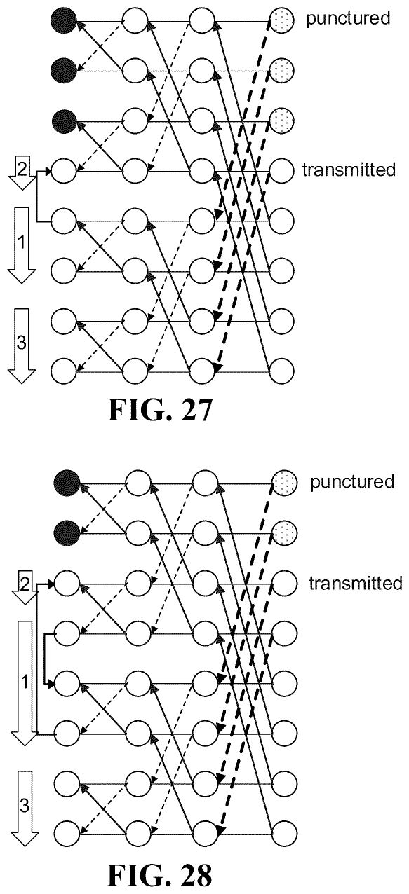

FIG. 27 is a diagram of a trellis, illustrating an example of decoding that involves non-sequential polar code decoding. The example in FIG. 27 is for a length-8 code where the first 3 code bits are punctured, and the decoding scheduling sequence is DS=[5, 6, 4, 7, 8]. In the example shown in FIG. 27, bit values for the bit indices 4 and 5 are the same, and the return arrow from position 5 to position 4 at the left in FIG. 27 is intended to represent the fact that the bit value for bit index 4 is known after the bit value for bit index 5 has been decoded.

To reduce description complexity, the decoding scheduling sequence may be shortened to indicate only non-sequential parts. If there is a consecutive sequential subsequence [i, i+1 . . . j], for example, this can be represented as [i, j] for simplicity. A full decoding scheduling sequence DS=[i₁, i₂, i₃ . . . i_{M}] which can be represented as DS=[i₁, . . . , iₜ, iₜ₊₁ . . . i_{M}], where “ . . . ” are consecutive indices, can be reduced to DSₛ=[i₁, iₜ, iₜ₊₁, i_{M}]. For example, DS=[5, 6, 7, 2, 3, 4, 8] can be reduced to DSₛ=[5, 7, 2, 4, 8].

FIG. 28 is a diagram of a trellis, illustrating another example of decoding that involves non-sequential polar code decoding. In this example of a length-8 code, the first 2 code bits are punctured, and the decoding scheduling sequence is DS=[4, 5, 6, 3, 7, 8], or shortened as DSₛ=[4, 6, 3, 7, 8]. In the example shown in FIG. 28, bit values for the bit indices 4 and 5 are the same, and bit values for the bit indices 3 and 6 are the same. The arrows from position 4 to position 5 and from position 6 to position 3 at the left in FIG. 28 are intended to represent this. Regarding indices 4 and 5, FIG. 28 is different from FIG. 27 in that the bit value for bit index 5 is decoded first in FIG. 27, but the bit value for bit index 4 is decoded first in FIG. 28. Decoding orders in which information/frozen/PC bits are no longer decoded in serial order, but in parallel, are also possible. In cases in which there are multiple bits that have the same value, according to a PC function for example, they can be hard decided in parallel after combining their soft information such as LLRs. The decoding order in each parallel decoding block can be sequential, or non-sequential.

A parallel decoding order can be represented by a set of decoding scheduling sequences, instead of only one sequence. If there are p blocks that are to be decoded in parallel, then there may be p decoding scheduling sequences, including a respective decoding scheduling sequence for each block. This may be expressed as follows, as an example:

$$D {S}_{1} = [ {i}_{1} , {i}_{2} … ] , D {S}_{2} = [ {j}_{1} , {j}_{2} … ] , … , {DS}_{p} = [ {k}_{1} , {k}_{2} … ] .$$

Any bits that are to be simultaneously hard decided can be represented by index tuples, which are pairs in the case of two bits to be hard decided at the same time, triples as in the following examples in the case of three bits to be hard decided at the same time, and so on:

$$( {i}_{r} = {j}_{s} = {k}_{t} ) , ( {i}_{r + 4} = {j}_{s + 2} = {k}_{t + 1} ) , …$$

The above examples illustrate that bits that are to be simultaneously hard decided need not have corresponding positions in the decoding scheduling orders of parallel decode blocks. Such bits also need not be in the same position within their respective blocks. In the first example above, the r-th index in DS₁, the s-th index in DS₂, and the t-th index in DS₃ are to be simultaneously hard decided. All of r, s, and t in this example, or any two of them, may be the same, or they may all be different.

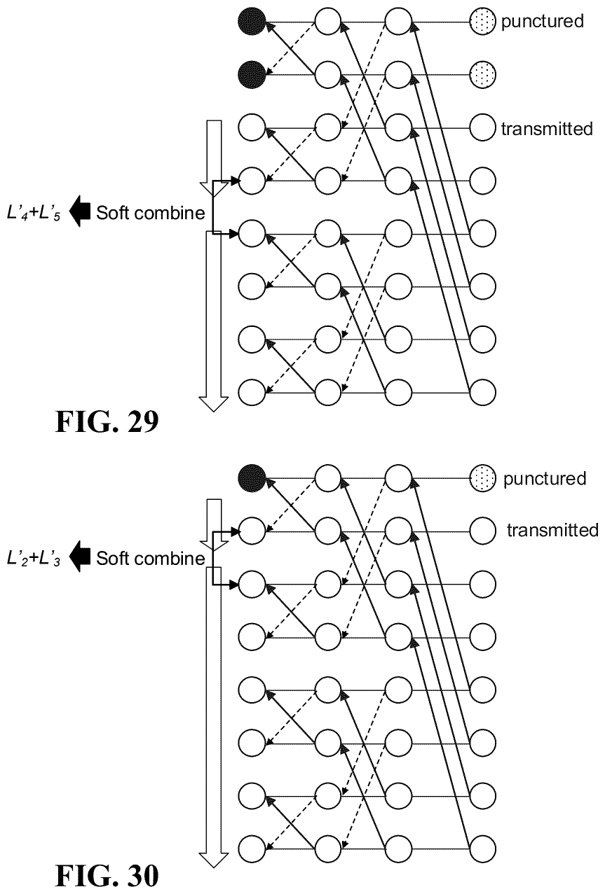

FIG. 29 is a diagram of a trellis, illustrating a further example of decoding that involves non-sequential polar code decoding. In the example shown, the upper half and lower half of the trellis are decoded in parallel. The decoding scheduling sequences are DS₁=[3, 4], DS₂=[5, 6, 7, 8], and (4=5). As seen, for the 4^{th} and 5^{th} indices, their bit values are the same, and therefore their soft information such as LLRs L′₄ and L′₅ are combined first in this example, and then a joint hard decision is made: u₄=u₅=(1−sign (L′₄+L′₅))/2.

FIG. 30 is a diagram of a trellis, illustrating yet another example of decoding that involves non-sequential polar code decoding. In the example shown, as in the above example that refers to FIG. 29, the two parallel-decoded blocks have different sizes. More generally, blocks that are to be parallel-decoded may be of the same size or different sizes.

The decoding scheduling sequences in the example shown in FIG. 30 are DS₁=[2], DS₂=[3,4,5,6,7,8], and (2=3). As seen, for the 2^{nd} and 3^{rd} indices, their bit values are the same, and therefore their soft information such as LLRs L′₂ and L′₃ are combined first in the example shown, and then a joint hard decision is made: u₂=u₃=(1−sign (L′₂+L′₃))/2.

In these two examples, the splitting point between two blocks, denoted 0 for ease of reference, are different. They are 4 and 2, respectively. In practice, a splitting point can be set as mother code length N divided by a power of 2 integer, such as 0=N/2, N/4, N/8, N/16, etc., and their combination sums, such as 0=N/2+N/4, 0=N/2+N/8, 0=N/2+N/4+N/16, etc.

In embodiments that may be referred to herein as bidirectional decoding, directions of decoding different blocks can be different. For example, one block may be decoded in sequential order, while another block is decoded in reverse sequential order.

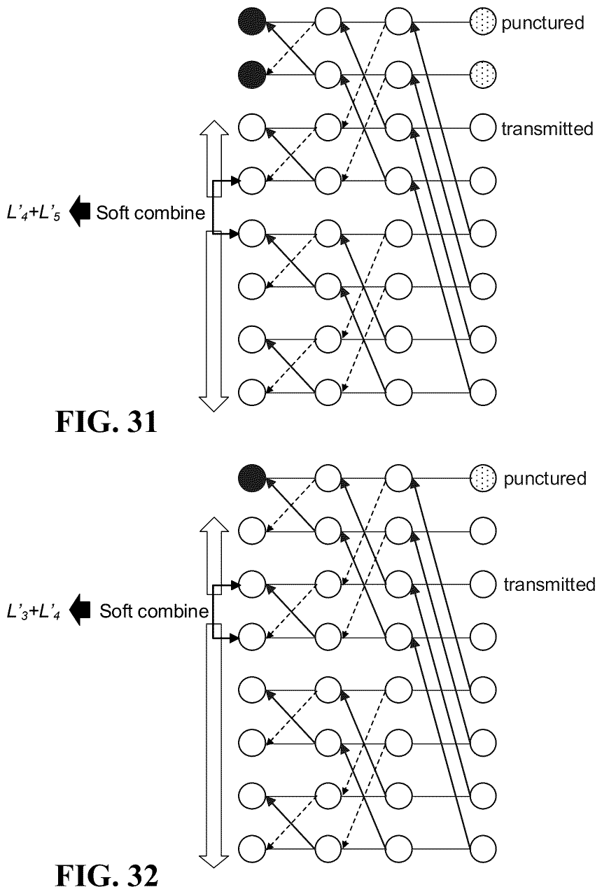

FIG. 31 is a diagram of a trellis, illustrating a bidirectional decoding example according to an embodiment. In the example shown, the upper and lower half of the trellis are decoded in parallel, but in different directions. Although the example in FIG. 31 is for parallel-decoded blocks, bidirectional decoding may be applied to serially decoded blocks.

The decoding scheduling sequences in FIG. 31 are DS₁=[4, 3], DS₂=[5, 6, 7, 8], and (4=5). As seen, the bit values for the 4th and 5th indices are the first decoded bit in each block and are the same, and therefore their soft information such as LLRs L′₄ and L′₅ are combined in the example shown and then a joint hard decision is made: u₄=u₅=(1−sign(L′₄+L′₅))/2.

FIG. 32 is a diagram of a trellis, illustrating another bidirectional decoding example. In this example, the two parallel-decoded blocks have different sizes. The decoding scheduling sequences are DS₁=[3, 2], DS₂=[4, 5, 6, 7, 8], and (3=4). As seen, the bit values for the 2^{nd} and 3^{rd} indices are the first decoded in each block and are the same, and therefore their soft information such as LLRs L′₃ and L′₄ can be combined and then a joint hard decision can be made: u₃=u₄=(1−sign (L′₃+L′₄))/2.

Bit labeling, non-sequential decoding, or both, may be applied in conjunction with other features disclosed herein, such as those disclosed by way of example below with reference to various illustrative embodiments.

The following embodiments, and others herein, are provided as examples as to how such features and procedures may be put into practice.

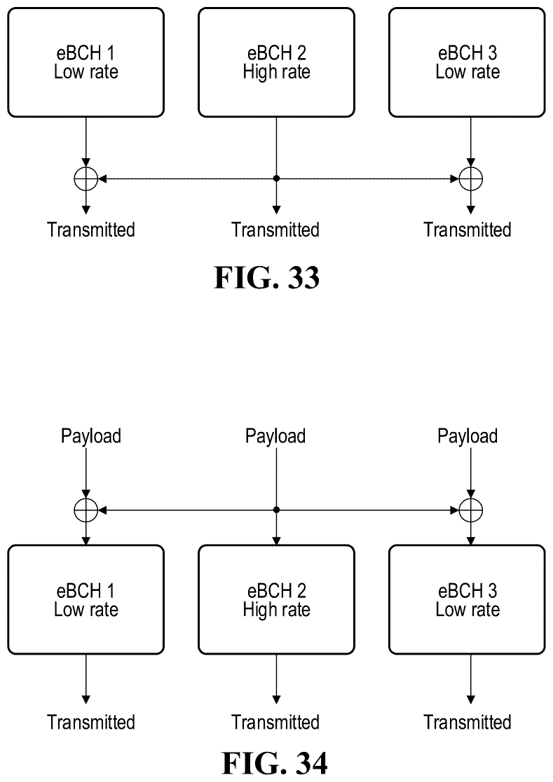

FIG. 33 illustrates coding with block coupling according to an embodiment. The example shown relates to what may be referred to as a hybrid code. The hybrid code in this example consists of three blocks, and each block is an eBCH code. The first (eBCH 1) and third (eBCH 3) codes have low blockwise code rates that may be the same or different, and the second (eBCH 2) code has a high code rate. Any of various thresholds or limits may be used to define or delineate what may be considered a low code rate and a high code rate, or a code rate may be considered low or high based on relative code rates. For example, a highest blockwise code rate (or a number of the highest blockwise code rates) among blocks may be considered high code rate(s), and any other blockwise code rate(s) lower than the high code rate(s) may be considered low code rate(s).

The high code rate block for the second eBCH code is coupled with the low code rate blocks for both the first and third eBCH codes in FIG. 33. The block coupling in this example is implemented or provided by combining one or more code bits of the block for the second eBCH code (by an XOR operation in the example shown) with one or more code bits of each of the blocks for the first and third eBCH codes to generate final code bits for output. The code bits for the second eBCH code are directly output. The final output code bits are transmitted in the example shown.

FIG. 34 illustrates coding with block coupling according to another embodiment. The high code rate block for the second eBCH code is coupled with the low code rate blocks for both the first and third eBCH codes, as in FIG. 33, but in a different way. The block coupling in this example is implemented or provided by combining one or more payload bits or input bits to encoding for the second eBCH code (by an XOR operation in the example shown) with one or more payload bits or input bits to encoding for each of the first and third eBCH codes to generate output code bits. The code bits of all of the eBCH codes are output, for transmission in this example.

The second eBCH code, and thus the code bit block obtained from encoding by the second eBCH code, has the highest code rate R_{b1} and its capacity C_{b1} may also be the highest capacity. The first and third eBCH codes, and thus the code bit block obtained from encoding by each of these eBCH codes, have a lower code rate and possibly lower capacity. Blockwise rate-to-capacity ratios may be expressed as: R_{b1}/C_{b1}, R_{b2}/C_{b2}, R_{b3}/C_{b3}.

Consider an example in which the three eBCH codes have the same length, and go through the same channel, with R_{b1}=R_{b3}<R_{b2} and C_{b1}=C_{b3}<C_{b2}. In this example, decoding order may be determined, by or at a decoder or decoding device, according to the following in some embodiments:
if R_{b2}/C_{b2}<R_{b1}/C_{b1}, then the second eBCH code is decoded first, and then the other two eBCH codes are decoded;
if R_{b2}/C_{b2}>R_{b1}/C_{b1}, then the first and third eBCH codes are decoded first, and then the second eBCH code is decoded.

These conditions or criteria may also or instead be used, by or at an encoder or encoding device, in determining transmission or output order. At least blockwise code rates are known at an encoder or encoding device, and channel condition measurements or estimates may also be available for estimating capacity.

In another example with the three eBCH codes again having the same length but going through different channels, suppose that R_{b1}<R_{b3}<R_{b2}, C_{b3}<C_{b1}<C_{b2}, decoding order may be determined, by or at a decoder or decoding device, according to the following in some embodiments:
if R_{b1}/C_{b1}<R_{b3}/C_{b3}, then the third eBCH code is decoded first;
blockwise rate-to-capacity ratios of the remaining two eBCH codes can then be re-calculated or determined, and:
if R′_{b1}/C′_{b1}<R′_{b2}/C′_{b2}, where R′ and C′ denote blockwise code rate and capacity after decoding the third eBCH code, then the first eBCH code is decoded next, and finally the 2^{nd} eBCH code;
if R′_{b1}/C′_{b1}>R′_{b2}/C′_{b2}, then the second eBCH code is decoded next, and finally the first eBCH code.

The conditions or criteria outlined above may also or instead be used, by or at an encoder or encoding device, in determining transmission or output order. As noted above, at least blockwise code rates are known at an encoder or encoding device, and channel condition measurements or estimates may also be available for estimating capacity. Variable code rates and/or capacities may also be estimated based on expected decoding order in determining transmission or output order.

These examples use eBCH codes, which are good candidates because they naturally support variable code rates. For eBCH codes of length 64, they have code rates equivalent to the following numbers of information bits (K), where a lower-rate code is a subcode of a higher-rate code.

| N | K₁ | K₂ | K₃ | K₄ | K₅ | K₆ | K₇ | K₈ | K₉ | K₁₀ | K₁₁ | K₁₂ |
|---|---|---|---|---|---|---|---|---|---|---|---|---|
| 64 | 2 | 8 | 11 | 17 | 19 | 25 | 31 | 37 | 40 | 46 | 52 | 58 |

Consistent with embodiments disclosed herein and the examples in FIGS. 33 and 34, different information bits or bit values may be assigned as payload bits or input bits to the three eBCH codes up to K=25, and then assign the same information bits to more than one eBCH code up to K=37.

FIGS. 33 and 34 are examples only.

Embodiments are not limited to eBCH codes, polar codes for which various features are described in detail elsewhere herein, or any other specific codes.

There may be more or fewer than three codes or code bit blocks.

An XOR operation applied to code bits or input bits for different blocks is one example of how blocks may be coupled to each other. Code bits or input bits may be combined or related to each other in other ways, by a check node or function for example. Bit value placement may also or instead be used for block coupling, with the same bit value being placed on multiple polar code bit indices in different input blocks for example, to couple the code bit blocks that correspond to those input bit blocks.

Block coupling need not necessarily include all blocks as in the examples shown. There may be one or more blocks that are not coupled to any other blocks. The coupling examples are also not mutually exclusive. For example, blocks may be coupled in different ways (such as one block pair being output coupled as in FIG. 33 and the other block pair being input coupled as in FIG. 34). Blocks may also or instead be coupled in multiple ways (such as by output coupling as in FIG. 33 and input coupling as in FIG. 34).

More generally, transmission or output order, and/or decoding order or decoding scheduling, may be determined according to any of various conditions or rules, such as one or more of the following:
always output or decode a capacity-sufficient block (based on blockwise code rate, blockwise capacity, or a blockwise rate-to-capacity ratio for example) of code bits first;
between blocks that are input coupled, as shown by way of example in FIG. 34 or by placement of the same bit value on multiple input bit indices for different code bit blocks for example, as an information bit is decoded, its associated bit value(s) will be known or can be determined, and can be treated as a type of known bit or frozen bit for decoding of another block;
as bit values of more information bits in another block become known from decoding bit values from other code bit blocks or from other bit indices, that other block will become capacity-sufficient, and decoding can then be switched to that other block;
between blocks that are output coupled, as shown by way of example in FIG. 33, code bits from a successfully decoded block can be used to determine any coupled code bits in any coupled code block(s), to potentially aid in decoding the coupled code block(s);
output coupling of code bit blocks can also impact capacity of coupled code bit blocks, which may become capacity-sufficient as code bit values from other code blocks are successfully decoded, and decoding can then be switched based on block capacity sufficiency.

### Overview

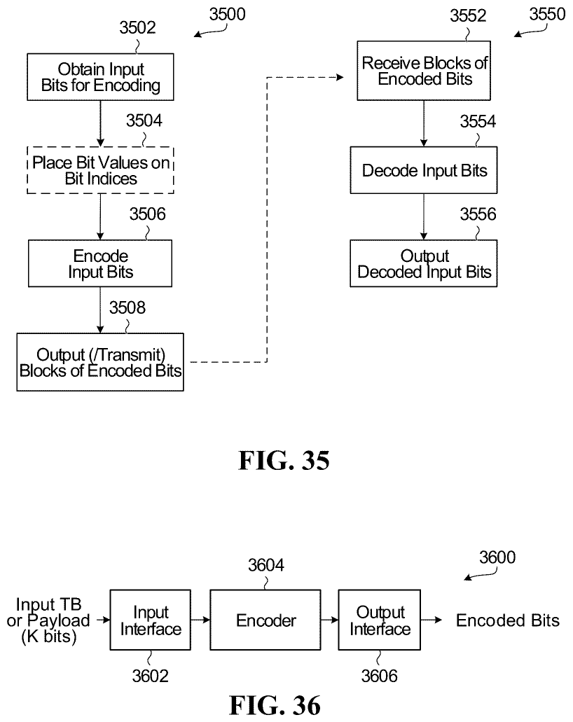

Various aspects of the present disclosure are described herein and shown in the drawings by way of example. FIG. 35 is a flow diagram illustrating more general example methods according to embodiments. At the left, 3500 in FIG. 35 illustrates operations or features that may be provided or supported at an encoder or transmitter-side device, and at the right, 3550 illustrates operations or features that may be provided or supported at a decoder or receiver-side device. For ease of reference, in the following description of FIG. 35, a device at which encoding and/or transmitting features may be implemented or supported is called a first communication device, and a device at which decoding and/or receiving features may be implemented or supported is called a second communication device. Embodiments may involve either or both of such devices.

With reference first to 3500, from a transmitting device perspective the outputting of blocks of encoded bits at 3508 may involve transmitting the blocks of encoded bits. Blocks of encoded bits may be output through or via any of various types of interface, including a communication interface in the case of transmitting the blocks of encoded bits. Embodiments are not in any way restricted to any particular type of interface. The blocks of encoded bits may be transmitted at 3508 by a first communication device to a second communication device in a wireless communication network, for example.

The blocks of encoded bits are obtained by encoding input bits at 3506, and may be referred to as encoded bits encoded by a code. Encoding at 3506 may be implemented or performed by an encoder or a processor, for example, and outputting the blocks of encoded bits at 3508 need not necessarily involve transmission of the blocks of encoded bits. The blocks of encoded bits may be output at 3508 for storage to memory for example, and/or transmission.

The encoding at 3506 may involve encoding the input bits by a polar code, for example. A polar code comprises or provides a number of bit indices for placing bit values before encoding. The bit indices include a first set of bit indices for placing values of input bits, and a second set of bit indices for placing a predetermined bit value.

In the context of blocks of encoded bits as disclosed herein, each of the blocks of encoded bits obtained by encoding the input bits at 3506 has a respective associated code rate and a respective associated capacity. The blocks of encoded bits include nested blocks, with each nested block being a subcode of another one of the blocks of encoded bits that has a higher respective associated code rate than the nested block. As described elsewhere herein, by definition a subcode is a subset of the codewords of a supercode, and in a nested structure of a codeword block, a low-rate code is a subcode of a high-rate code of the same length. BCH codes, polar codes, and LDPC codes are identified as examples of codes that can be constructed as variable-code-rate blocks using nested blocks. Further within this context of blocks of encoded bits, the nested blocks are or include coupled blocks that are coupled to each other.

Not all of the blocks of encoded bits are necessarily nested blocks. That is, at least some, but not necessarily all, of the blocks are nested blocks. In other words, the blocks of encoded bits include nested blocks, but do not necessarily consist of only nested blocks. Similarly, not all of the nested blocks are necessarily coupled blocks. At least some, but not necessarily all, of the nested blocks are coupled blocks, or in other words, the nested blocks include coupled blocks, but do not necessarily consist of only coupled blocks.

In a polar code embodiment, an information set including bit indices for placement of input bit values is an example of the above-referenced first set, and a frozen set including bit indices for placement of a predetermined frozen bit value is an example of the above-referenced second set. The first set of bit indices may include a first subset of bit indices associated with a first coupled block of the coupled blocks and a second subset of bit indices associated with a second coupled block of the coupled blocks that is coupled to the first coupled block.

Values of the input bits may include an input bit value (or in other words the same input bit value) that is placed on both a first bit index in the first subset and a second bit index in the second subset. Placement of bit values on bit indices is shown in dashed lines as an optional step or operation at 3504 in FIG. 35, but may be part of the encoding at 3506 in some embodiments. Although reference is made here to an input bit value that is placed on both a first bit index in the first subset and a second bit index in the second subset, embodiments may involve placing one bit value on multiple bit indices, or placing each of more than one bit value on multiple bit indices.

This type of coupling between coupled blocks is not restricted to polar codes. More generally, coupled blocks may be coupled to each other by a same bit value that is obtained or provided as input bits associated with the coupled blocks. In this example, the input bits are encoded to obtain the encoded bits in the coupled blocks, and in at least this sense the input bits are associated with the coupled blocks.

Another example of block coupling relates to coupled blocks being coupled to each other via coupling between variable nodes that are associated with the coupled blocks. The variable nodes may be coupled by a check node in some embodiments. Variable nodes and check nodes are discussed by way of example elsewhere herein, and FIG. 14 illustrates an example of check node coupling between variable rate blocks.

Coupled blocks may be coupled to each other via combining encoded bits associated with the coupled blocks, as shown by way of example in FIG. 33 as combining by an XOR operation, and/or via combining input bits associated with the coupled blocks as shown by way of example in FIG. 34 as combining by an XOR operation.

Some embodiments may involve ordering the blocks of encoded bits based on the respective associated code rate and the respective associated capacity of each of the blocks of encoded bits. Such ordering may be useful for decoding, in that the blocks of encoded bits may be transmitted or otherwise output in an order in which they are expected to be decoded. Decoding order may be the same as the transmission or output order in some embodiments, but decoding order may be determined by a decoder, decoding device, or receiving device, based on channel condition for example, and may or may not be the same as the transmission or output order that is determined by an encoder, encoding device, or transmitting device.

Ordering of the blocks of encoded bits may be performed or supported by an encoder or by another component or device. For example, an encoder may be configured to encode the input bits and order the blocks of encoded bits for output. This is an example of how ordering may be performed before output of the blocks of encoded bits. In some embodiments, an encoder may instead output the blocks of encoded bits in sequential order in which the encoded bits are generated or obtained in an encoded bit stream, and a transmitter or other component or device may be configured for ordering the blocks of encoded bits, output by the encoder, by code rate and capacity. This is an example of how ordering may be performed after output of the blocks of encoded bits by an encoder.

Such ordering the blocks of encoded bits based on code rate and capacity may involve ordering the blocks in increasing order of a ratio of the respective associated code rate of each of the blocks of encoded bits to the respective associated capacity of each of the blocks of encoded bits. This may also or instead be referred to as ordering in increasing order of blockwise code rate to capacity ratio.

Encoded bits may be transmitted or otherwise output in sequential order according to an order of encoded bits in an encoded bit stream, or in a different order. Regardless of whether encoded bits are transmitted or otherwise output in sequential order, in some embodiments values of input bits may be decodable from the blocks of encoded bits according to a non-sequential decoding order that is based on the respective associated code rate and the respective associated capacity of each of the blocks of encoded bits. This is also referred to herein as flexible decoding order.

In some embodiments, the blocks of encoded bits include a block for which the respective associated code rate, the respective associated capacity, or both the respective associated code rate and the respective associated capacity, are variable and change as another block of encoded bits is decoded. With block coupling, for example, decoding of one block can impact code rate and/or capacity associated with any coupled blocks that are coupled to the block that is being decoded. In an example above, a decoding order based on blockwise rate-to-capacity ratio involves decoding the block with the smallest rate-to-capacity ratio, and updating the rate-to-capacity ratio of each block during decoding because they will change, at least in the case of coupled blocks.

For completeness, FIG. 35 illustrates another operation that may be involved in a method according to some embodiments at 3502. Obtaining input bits for encoding may involve, for example, collecting or otherwise receiving data outputs from one or more devices and/or services, or accessing data in a memory.

Embodiments may include any or all of the operations illustrated at 3500. For example, in some embodiments, a method may involve encoding as shown at 3506 and transmitting or otherwise outputting blocks of encoded bits at 3508. Other embodiments may involve transmitting or otherwise outputting, at 3508, blocks of encoded bits that have already been obtained by encoding input bits. Other methods may involve the obtaining, placing, and encoding 3502, 3504, 3506, and also outputting encoded bits as shown at 3508.

Features may be implemented in any of various ways, and/or other features may also or instead be provided or supported.

Outputting at 3508 may involve transmitting in some embodiments, or these features may be implemented separately, by an encoder and a transmitter for example. The encoding at 3506 may generate encoded bits, and blocks of those encoded bits may be output at 3508.

Some embodiments may involve rate matching, by puncturing or shortening for example, and as a result some bit indices may have zero or very low reliability or capacity. As described at least above, null bits may be defined, in addition to frozen bits and information bits, to bits with such low capacity that it is not to be decoded, and similarly null bit indices may be defined as bit indices for placement of input bit values.

Null bit indices may be related to reducing the number of encoded bits that are generated by the encoding at 3506. In general if there are P punctured positions from which encoded bits are punctured, for example, then there will be exactly P null bit indices. Puncturing the first P bit positions at the first P indices in a codeword of a polar code, for example, will most significantly degrade the first P bit indices in an input vector, and those first P bit indices may be marked or otherwise indicated as or treated as null bit indices. Similarly, for many other puncturing patterns, a null bit pattern is identical to the puncturing pattern, such that null bit indices are the same indices as puncture bit indices from which encoded bits are punctured. There can be exceptions, especially when puncturing from the end of a codeword, in which case the null bit pattern is different from the puncturing pattern, and for such scenarios a null bit pattern or its relationship to a puncturing pattern may be defined or specified in a communication standard for example.

In general terms, there is a relationship between bit indices of encoded bits that are punctured or otherwise reduced, in rate matching for example, and null bit indices in an input vector that are most significantly impacted or affected by reducing the number of encoded bits. Correspondence between a number of punctured bits and a number of null bit positions and correspondence between punctured and null bit indices are examples of relatively simple deterministic relationships.

Null bit indices may be determined, by a decoder or at a receiver or decoding device, based on a puncturing pattern that is known, for example. Signaling or configuration may also or instead be used to indicate null bit indices in other embodiments.

Encoding and decoding embodiments may be impacted by null bits. For example, if a null bit index is also part of an information set, then an input bit value that has been placed on that bit index may also be placed on another bit index that becomes part of the information set, so that the input bit value can be properly decoded. The input bit value may remain on the null bit index, and that input value may be encoded, but the corresponding encoded bit will not be transmitted or otherwise provided to a decoder and the input bit value will not be decoded at that null bit index.

This is different from conventional decoding of rate-matched codes. Although both types of decoding (conventional and null bit embodiments) may involve setting soft information such as LLRs for punctured bits to 0 for example, null bit indices are skipped entirely for decoding. In contrast, conventional decoding does not skip any bit positions for decoding but rather still attempts to decode bit values at indices that correspond to punctured bits.

In embodiments in which input bit values are placed on null bit indices, those input bit values are preferably also placed on one or more other bit indices, so that they can be decoded.

Bit indices or positions (subchannels in the case of a polar code) for bit values before encoding may be assigned and thereby associated with labels, which is one possible way to place bit values on bit indices. These bit indices include at least information bit indices for values of input bits that are to be encoded (also referred to herein as information bits), and may also include frozen bit indices for frozen bits that are set to a predetermined known bit value, and/or null bit indices for null bits. For information bits and frozen bits, the frozen bit positions may be labeled as “0” or another value that is not used for information bits, and the information bit positions (K in number) may labeled as l∈{1, 2 . . . . K}. More generally, information bit indices are for placing input bit values, frozen bit indices are for placing a predetermined value, and null bit indices, if provided, are also for placing input bit values and reducing a number of encoded bits. Code construction and encoding may be performed according to the bit value placement.

For multiple bit indices to which the same label is assigned or on which the same bit value is placed, once the bit value at any one of these bit indices is decoded, the remaining bits at indices with the same bit value or label are immediately known, because of the relationship or check-type function that is created by the common, shared bit value or label. Decoding of an input bit for a first bit index among bit indices that have the same bit value or label may be according to a polar code, whereas decoding for other bit indices associated with the same bit value or label may reduce to setting the bit values to the same value as the first decoded input bit, based on the label or the same bit value having been placed on those other bit indices. In this sense, the first decoded bit is processed as an information bit in terms of encoding and decoding. The other information bits at bit indices associated with the same bit value or label need not undergo the same decoding that would normally be applied to information bits, and in this sense may be considered a form of check bit.

At 3550, FIG. 35 illustrates various decoding and/or receiving counterparts of features shown at 3500. From a receiving device perspective, the receiving at 3552 represents receiving blocks of encoded bits that have been obtained by encoding input bits by a code. The receiving at 3552 may involve receiving the blocks of encoded bits from a first communication device by a second communication device in a wireless communication network, for example. Encoded bits may be received through or via any of various types of interface, and embodiments are not in any way restricted to any particular type of interface.

As in other embodiments herein, each of the blocks of encoded bits has a respective associated code rate and a respective associated capacity, the blocks of encoded bits comprising nested blocks, each nested block is or includes a subcode of another one of the blocks of encoded bits that has a higher respective associated code rate than the nested block, and the nested blocks include coupled blocks that are coupled to each other.

The decoding at 3554 is intended to illustrate decoding the received encoded bits to obtain decoded input bits. Decoding at 3554 may be implemented or performed by a decoder or a processor, for example.

In some embodiments, a decoder might not be a discrete device, but rather a block of logic in silicon or part of a system-on-chip that decodes and uses the decoded input bits. In other embodiments, the decoded input bits are output as shown at 3556, for processing and/or storage, for example.

Any or all of the features that are described herein in the context of encoder-side or transmitter-side methods, with reference to operations at 3500 in FIG. 35, for example, may also apply to or have counterpart features in a decoder-side or receiver-side method. Other features may also or instead be provided or supported. Any one or more of the following features, for example, may be provided or supported, individually or in any of various combinations, in a decoder-side or receiver-side method:
the coupled blocks may be coupled to each other via coupling between variable nodes associated with the coupled blocks;
the variable nodes may be coupled by a check node;
the coupled blocks may be coupled to each other via combining encoded bits associated with the coupled blocks;
the coupled blocks may be coupled to each other via combining input bits associated with the coupled blocks;
the coupled blocks are coupled to each other by a same bit value as input bits associated with the coupled blocks;
the encoded bits may have been obtained by encoding the input bits by a polar code to obtain the encoded bits, with the polar code including a number of bit indices for placing bit values before encoding, the bit indices including: a first set of bit indices for placing values of the input bits and a second set of bit indices for placing a predetermined bit value, the first set of bit indices including a first subset of bit indices associated with a first coupled block of the coupled blocks and a second subset of bit indices associated with a second coupled block of the coupled blocks that is coupled to the first coupled block, and the values of the input bits including the same bit value placed on both a first bit index in the first subset and a second bit index in the second subset;
the receiving at 3552 may involve receiving the blocks of encoded bits in an order based on the respective associated code rate and the respective associated capacity of each of the blocks of encoded bits;
the decoding at 3554 may involve decoding the blocks of encoded bits in an order that is different from the order in which the blocks of encoded bits are received;
the decoding at 3554 may involve decoding the blocks of encoded bits in increasing order of a ratio of the respective associated code rate of each of the blocks of encoded bits to the respective associated capacity of each of the blocks of encoded bits;
the decoding at 3554 may involve decoding values of the input bits from the blocks of encoded bits according to a non-sequential decoding order that is based on the respective associated code rate and the respective associated capacity of each of the blocks of encoded bits;
the blocks of encoded bits received at 3552 may include a block for which the respective associated code rate, the respective associated capacity, or both the respective associated code rate and the respective associated capacity, are variable and change as another block of encoded bits is decoded;
a method may involve updating the respective associated code rate to a respective updated code rate, the respective associated capacity to a respective updated capacity, or both the respective associated code rate and the respective associated capacity to the respective updated code rate and the respective updated capacity for the block as the other block of encoded bits is decoded at 3554;
the decoding at 3554 may involve decoding the block in an order based on the respective updated code rate, the respective updated capacity, or both the respective updated code rate and the respective updated capacity for the block.

Other features related to receiving and/or decoding encoded bits may also or instead be provided. For example, decoding order may be based on any of various conditions or criteria, examples of which are provided elsewhere herein. The specific examples listed above are not exhaustive. An order of transmitting or otherwise outputting, and/or receiving, blocks of encoded bits may be based on the same or similar criteria or conditions.

Embodiments may involve other features or operations as well. For example, some embodiments may involve communicating signaling that is indicative of any of various parameters, such as any one or more of: code length, puncturing pattern, base sequence for determining an information set and a frozen set, etc. Communicating of signaling may involve transmitting the signaling by an encoder/encoding device or a transmitter/transmitting device that is to transmit encoded bits, to a decoder/decoding device or a receiver/receiving device. The communicating may also or instead involve receiving the signaling by a decoder/decoding device or a receiver/receiving device from an encoder/encoding device or a transmitter/transmitting device. Signaling need not necessarily be between, or only between, communication devices by which encoded bits are to be transmitted or received. For example, a network device such as a gNB or a base station may transmit signaling to configure parameters at one or more communication devices. Therefore, a method may involve a network device transmitting signaling, and an encoder/encoding device or a transmitter/transmitting device receiving the signaling from the network device, and/or a decoder/decoding device or a receiver/receiving device receiving the signaling from the network device.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor that is configured, by executing programming for example, to cause the apparatus to perform a method or operations, or to provide or support features, disclosed herein. An apparatus may also include a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, programming stored in or on a non-transitory computer readable storage medium may include instructions to or to cause a processor to, or a processor, device, or other component may otherwise be configured to, encode input bits to obtain blocks of encoded bits, and output the blocks of encoded bits. Each of the blocks of encoded bits has a respective associated code rate and a respective associated capacity, the blocks of encoded bits include nested blocks, and each nested block includes a subcode of another one of the blocks of encoded bits that has a higher respective associated code rate than the nested block. The nested blocks include coupled blocks that are coupled to each other.

Apparatus embodiments are not limited to the foregoing examples, or to processor-based or programming-based embodiments. An apparatus may also or instead include, for example, an encoder for encoding the input bits to obtain the blocks of encoded bits, and an interface coupled to the encoder for outputting the blocks of encoded bits. As in other embodiments, each of the blocks of encoded bits has a respective associated code rate and a respective associated capacity, the blocks of encoded bits include nested blocks, each nested block includes a subcode of another one of the blocks of encoded bits that has a higher respective associated code rate than the nested block, and the nested blocks include coupled blocks that are coupled to each other.

Encoded bits may be output via any of various types of interface, including a communication interface in the case of transmitting the encoded bits. Embodiments are not in any way restricted to any particular type of interface, the implementation of which may be based at least in part on how encoded bits are to be output.

FIG. 36 is a block diagram illustrating an apparatus in which embodiments may be implemented or supported. The example apparatus 3600 includes an input interface 3602, an encoder 3604 coupled to the input interface, and an output interface 3606 coupled to the encoder. Input bits for encoding are shown as input TB or payload bits, and encoded bits are shown as an output from the output interface 3606. Although shown as a separate output interface 3606 in FIG. 36, an interface for transmitting or otherwise outputting blocks of encoded bits may be provided by, incorporated into, or coupled to the encoder 3604. Similarly, although shown as a separate input interface 3602 in FIG. 36, an interface through which input bits for encoding may be provided to or obtained by the encoder 3604 may be provided by, incorporated into, or coupled to the encoder.

Encode-side or transmit-side features or functions, and other features or functions herein, may be implemented in any of various ways, such as in hardware, firmware, or one or more components that execute software. The present disclosure is not limited to any specific type of implementation, and implementation details may vary between different devices, for example.

In an embodiment, an apparatus includes the encoder 3604 for encoding input bits to obtain blocks of encoded bits. Each of the blocks of encoded bits has a respective associated code rate and a respective associated capacity. The blocks of encoded bits include nested blocks, and each nested block includes a subcode of another one of the blocks of encoded bits that has a higher respective associated code rate than the nested block. The nested blocks include coupled blocks that are coupled to each other.

More generally, an apparatus or a component thereof such as an encoder 3604 or a processor may be configured to encode (or for encoding) input bits, or programming may include instructions to encode (or for encoding) input bits or to cause a processor to encode input bits, to obtain blocks of encoded bits. An apparatus or a component thereof such as an interface 3606 coupled to the encoder 3604 may be configured to output (or for outputting), or programming may include instructions to output (or for outputting) or to cause a processor to output, the blocks of encoded bits. Outputting may involve transmitting the blocks of encoded bits by a first communication device to a second communication device in a wireless communication network for example.

Embodiments related to such apparatus or non-transitory computer readable storage media may include any one or more of the following features, for example, which are also discussed elsewhere herein:
the coupled blocks may be coupled to each other via coupling between variable nodes associated with the coupled blocks;
the variable nodes may be coupled by a check node;
the coupled blocks may be coupled to each other via combining encoded bits associated with the coupled blocks;
the coupled blocks may be coupled to each other via combining input bits associated with the coupled blocks;
the coupled blocks may be coupled to each other by a same bit value as input bits associated with the coupled blocks;
the apparatus or a component thereof such as an encoder 3604 may be configured to encode (or for encoding), or programming may include instructions to encode (or for encoding) or to cause a processor to encode the input bits by a polar code to obtain the encoded bits, the polar code including a number of bit indices for placing bit values before encoding, the bit indices including: a first set of bit indices for placing values of the input bits and a second set of bit indices for placing a predetermined bit value, the first set of bit indices including a first subset of bit indices associated with a first coupled block of the coupled blocks and a second subset of bit indices associated with a second coupled block of the coupled blocks that is coupled to the first coupled block;
the values of the input bits may include the same bit value placed on both a first bit index in the first subset and a second bit index in the second subset;
the apparatus or a component thereof such as an encoder 3604 may be configured to order (or for ordering), or programming may include instructions to order (or for ordering) or to cause a processor to order the blocks of encoded bits based on the respective associated code rate and the respective associated capacity of each of the blocks of encoded bits;
the apparatus or a component thereof such as an encoder 3604 may be configured to order (or for ordering), or programming may include instructions to order (or for ordering) or to cause a processor to order the blocks of encoded bits in increasing order of a ratio of the respective associated code rate of each of the blocks of encoded bits to the respective associated capacity of each of the blocks of encoded bits;
values of the input bits may be decodable from the blocks of encoded bits according to a non-sequential decoding order that is based on the respective associated code rate and the respective associated capacity of each of the blocks of encoded bits;
the blocks of encoded bits may include a block for which the respective associated code rate, the respective associated capacity, or both the respective associated code rate and the respective associated capacity, are variable and change as another block of encoded bits is decoded;
the apparatus or a component thereof such as an interface 3606 may be configured to transmit (or for transmitting), or programming may include instructions to transmit (or for transmitting) or to cause a processor to transmit the blocks of encoded bits from a first communication device to a second communication device in a wireless communication network.

For a decoder-side or receiver-side apparatus or a computer program product comprising a non-transitory computer readable storage medium to support decoder-side or receiver-side operations, the apparatus or a component thereof such as an interface may be configured to receive (or for receiving), or programming may include instructions to receive (or for receiving) or to cause a processor to receive, blocks of encoded bits obtained by encoding input bits. As in other embodiments, each of the blocks of encoded bits has a respective associated code rate and a respective associated capacity, the blocks of encoded bits include nested blocks, and each nested block includes a subcode of another one of the blocks of encoded bits that has a higher respective associated code rate than the nested block. The nested blocks include coupled blocks that are coupled to each other. Such an apparatus or a component thereof such as decoder coupled to the interface may be configured to decode (or for decoding), or programming may include instructions to decode (or for decoding) or to cause a processor to decode, the encoded bits to obtain decoded input bits.

Embodiments related to such apparatus or non-transitory computer readable storage media may include any one or more of the following features, for example, which are also discussed elsewhere herein:
the coupled blocks may be coupled to each other via coupling between variable nodes associated with the coupled blocks;
the variable nodes may be coupled by a check node;
the coupled blocks may be coupled to each other via combining encoded bits associated with the coupled blocks;
the coupled blocks may be coupled to each other via combining input bits associated with the coupled blocks;
the coupled blocks may be coupled to each other by a same bit value as input bits associated with the coupled blocks;
the encoded bits may have been obtained by encoding the input bits by a polar code to obtain the encoded bits, the polar code including a number of bit indices for placing bit values before encoding, the bit indices including: a first set of bit indices for placing values of the input bits and a second set of bit indices for placing a predetermined bit value, the first set of bit indices including a first subset of bit indices associated with a first coupled block of the coupled blocks and a second subset of bit indices associated with a second coupled block of the coupled blocks that is coupled to the first coupled block;
the values of the input bits comprising the same bit value placed on both a first bit index in the first subset and a second bit index in the second subset;
the apparatus or a component thereof such as an interface may be configured to receive (or for receiving), or programming may include instructions to receive (or for receiving) or to cause a processor to receive, the blocks of encoded bits in an order based on the respective associated code rate and the respective associated capacity of each of the blocks of encoded bits;
the apparatus or a component thereof such as a decoder may be configured to decode (or for decoding), or programming may include instructions to decode (or for decoding) or to cause a processor to decode, the blocks of encoded bits in an order that is different from the order in which the blocks of encoded bits are received;
the apparatus or a component thereof such as a decoder may be configured to decode (or for decoding), or programming may include instructions to decode (or for decoding) or to cause a processor to decode, the blocks of encoded bits in increasing order of a ratio of the respective associated code rate of each of the blocks of encoded bits to the respective associated capacity of each of the blocks of encoded bits;
the apparatus or a component thereof such as a decoder may be configured to decode (or for decoding), or programming may include instructions to decode (or for decoding) or to cause a processor to decode, values of the input bits from the blocks of encoded bits according to a non-sequential decoding order that is based on the respective associated code rate and the respective associated capacity of each of the blocks of encoded bits;
the blocks of encoded bits may include a block for which the respective associated code rate, the respective associated capacity, or both the respective associated code rate and the respective associated capacity, are variable and change as another block of encoded bits is decoded;
the apparatus or a component thereof such as a decoder may be configured to update (or for updating), or programming may include instructions to update (or for updating) or to cause a processor to update, the respective associated code rate to a respective updated code rate, the respective associated capacity to a respective updated capacity, or both the respective associated code rate and the respective associated capacity to the respective updated code rate and the respective updated capacity for the block as the other block of encoded bits is decoded;
the apparatus or a component thereof such as a decoder may be configured to decode (or for decoding), or programming may include instructions to decode (or for decoding) or to cause a processor to decode, the block in an order based on the respective updated code rate, the respective updated capacity, or both the respective updated code rate and the respective updated capacity for the block;
the apparatus or a component thereof such as an interface may be configured to receive (or for receiving), or programming may include instructions to receive (or for receiving) or to cause a processor to receive the blocks of encoded bits from a first communication device by a second communication device in a wireless communication network.

Apparatus embodiments are not in any way restricted to single devices. A system, for example, may include a first communication device and a second communication device. The first communication device may be configured to transmit (or for transmitting) blocks of encoded bits obtained by encoding input bits, each of the blocks of encoded bits having a respective associated code rate and a respective associated capacity, the blocks of encoded bits including nested blocks, each nested block including a subcode of another one of the blocks of encoded bits that has a higher respective associated code rate than the nested block, and the nested blocks including coupled blocks that are coupled to each other. The second communication device is configured to receive (or for receiving) the blocks of encoded bits from the first communication device, and to decode (or for decoding) the blocks of encoded bits to obtain decoded input bits. The first communication device in a system may also or instead implement, provide, or support other encode-side or transmit-side features disclosed herein, and similarly the second communication device in a system may also or instead implement, provide, or support other decode-side or receive-side features disclosed herein.

More generally, other features disclosed herein may also or instead be provided in method, apparatus, and/or system embodiments.

Embodiments disclosed herein encompass various aspects of coding, including encoding and decoding.

Disclosed embodiments may provide a fundamental upgrade of codes, and may make codes such as polar codes and/or other codes applicable for a much wider set of scenarios.

For example, disclosed embodiments may be implemented as part of a channel coding scheme, and may thus be applicable wherever channel coding is used. This covers a very wide range of scenarios. The flexibility provided by embodiments disclosed herein may help make the associated channel coding scheme particularly suitable for wireless communications.

Possible product deployments, in or in conjunction with which embodiments may be implemented, include network devices such as base stations, access devices such as UEs, robots, sensors, cars, drones, and satellites. Service deployment examples include enhanced mobile broadband (eMBB), ultra-reliable low latency communications (URLLC), massive machine type communications (mMTC)/Internet of things (IOT), and vehicular and industry scenarios. Network deployment examples include 5G+, 6G, WiFi, non-terrestrial networks (NTNs), optical networks, distributed networks, and self-organized networks. These are illustrative and non-limiting examples, and other deployments, implementations, or applications are possible.

Decoding as disclosed herein may be beneficial in helping avoid catastrophic performance degradation that may otherwise affect conventional approaches that use or support only sequential decoding.

More generally, embodiments may be advantageous in helping to achieve a channel-dependent coding structure or approach, which may provide or enable coding that can better adapt to channel state or condition changes.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

1. A method comprising:
encoding input bits to obtain blocks of encoded bits, each of the blocks of encoded bits being associated with a respective code rate and a respective capacity,
the blocks of encoded bits comprising nested blocks, each nested block of the nested blocks comprising a subcode of another block of the blocks of encoded bits that is associated with a higher respective code rate than the each nested block,
the nested blocks comprising coupled blocks that are coupled to each other; and
outputting the blocks of encoded bits.

2. The method of claim 1, wherein the coupled blocks are coupled to each other:
via coupling between variable nodes associated with the coupled blocks,
via combining encoded bits associated with the coupled blocks,
via combining input bits associated with the coupled blocks, or
by a same bit value as input bits associated with the coupled blocks.

3. The method of claim 1, further comprising:
ordering the blocks of encoded bits based on the respective code rate and the respective capacity of each of the blocks of encoded bits.

4. The method of claim 1, wherein values of the input bits are decodable from the blocks of encoded bits according to a non-sequential decoding order that is based on the respective code rate and the respective capacity of each of the blocks of encoded bits.

5. The method of claim 1, wherein the blocks of encoded bits comprise a block for which the respective code rate, the respective capacity, or both the respective code rate and the respective capacity, are variable and change as another block of encoded bits is decoded.

6. A method comprising:
receiving blocks of encoded bits obtained by encoding input bits, each of the blocks of encoded bits being associated with a respective code rate and a respective capacity,
the blocks of encoded bits comprising nested blocks, each nested block of the nested blocks comprising a subcode of another block of the blocks of encoded bits that is associated with a higher respective code rate than the each nested block,
the nested blocks comprising coupled blocks that are coupled to each other; and
decoding the encoded bits to obtain decoded input bits.

7. The method of claim 6, wherein the coupled blocks are coupled to each other:
via coupling between variable nodes associated with the coupled blocks,
via combining encoded bits associated with the coupled blocks,
via combining input bits associated with the coupled blocks, or
by a same bit value as input bits associated with the coupled blocks.

8. The method of claim 6, wherein the receiving comprises:
receiving the blocks of encoded bits in an order based on the respective code rate and the respective capacity of each of the blocks of encoded bits.

9. The method of claim 6, wherein the decoding comprises:
decoding the blocks of encoded bits in an increasing order of a ratio of the respective code rate of each of the blocks of encoded bits to the respective capacity of each of the blocks of encoded bits.

10. The method of claim 6, wherein the decoding comprises:
decoding values of the input bits from the blocks of encoded bits according to a non-sequential decoding order that is based on the respective code rate and the respective capacity of each of the blocks of encoded bits.

11. An apparatus comprising:
an encoder configured to encode input bits to obtain blocks of encoded bits, each of the blocks of encoded bits being associated with a respective code rate and a respective capacity,
the blocks of encoded bits comprising nested blocks, each nested block of the nested blocks comprising a subcode of another block of the blocks of encoded bits that is associated with a higher respective code rate than the each nested block,
the nested blocks comprising coupled blocks that are coupled to each other,
the apparatus further comprising:
an interface coupled to the encoder, configured to output the blocks of encoded bits.

12. The apparatus of claim 11, wherein the coupled blocks are coupled to each other:
via coupling between variable nodes associated with the coupled blocks,
via combining encoded bits associated with the coupled blocks,
via combining input bits associated with the coupled blocks, or
by a same bit value as input bits associated with the coupled blocks.

13. The apparatus of claim 11, wherein the encoder is configured to order the blocks of encoded bits based on the respective code rate and the respective capacity of each of the blocks of encoded bits.

14. The apparatus of claim 11, wherein values of the input bits are decodable from the blocks of encoded bits according to a non-sequential decoding order that is based on the respective code rate and the respective capacity of each of the blocks of encoded bits.

15. The apparatus of claim 11, wherein the blocks of encoded bits comprise a block for which the respective code rate, the respective capacity, or both the respective code rate and the respective capacity, are variable and change as another block of encoded bits is decoded.

16. An apparatus comprising:
an interface configured to receive blocks of encoded bits obtained by encoding input bits, each of the blocks of encoded bits being associated with a respective code rate and a respective capacity,
the blocks of encoded bits comprising nested blocks, each nested block of the nested blocks comprising a subcode of another block of the blocks of encoded bits that is associated with a higher respective code rate than the each nested block,
the nested blocks comprising coupled blocks that are coupled to each other,
the apparatus further comprising:
a decoder coupled to the interface, configured to decode the encoded bits to obtain decoded input bits.

17. The apparatus of claim 16, wherein the coupled blocks are coupled to each other:
via coupling between variable nodes associated with the coupled blocks,
via combining encoded bits associated with the coupled blocks,
via combining input bits associated with the coupled blocks, or
by a same bit value as input bits associated with the coupled blocks.

18. The apparatus of claim 16, wherein the interface is configured to receive the blocks of encoded bits in an order based on the respective code rate and the respective capacity of each of the blocks of encoded bits.

19. The apparatus of claim 16, wherein the decoder is configured to decode the blocks of encoded bits in an increasing order of a ratio of the respective code rate of each of the blocks of encoded bits to the respective capacity of each of the blocks of encoded bits.

20. The apparatus of claim 16, wherein the decoder is configured to decode values of the input bits from the blocks of encoded bits according to a non-sequential decoding order that is based on the respective code rate and the respective capacity of each of the blocks of encoded bits.
